(19) United States
(12) Patent Application Publication
(10) Pub. No.: US 2006/0155837 A1
(43) Pub. Date: Jul. 13, 2006

(54) Diskless computer operation management system

(76) Inventors: Ikuko Kobayashi, Kawasaki (JP); Shinji Kimura, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/080,541

(22) Filed: Mar. 16, 2005

(30) Foreign Application Priority Data
Jan. 13, 2005 (JP) 2005-005988

(51) Int. Cl. G06F 15/173

(52) U.S. Cl. 709/223

(57) ABSTRACT

The management and reliability of communications between computers and a storage system are improved. As between the primary and secondary communication ports of storage devices 20a, 20b, the system management server 10 sets the primary communication port as the current communication port as a default setting in each storage device. Where the system management server 10 monitors the primary and secondary communication ports and the current communication port fails or can otherwise no longer be used, the other communication port is set as the current communication port. The system management server 10 also manages the states of each communication port and the setting of the current communication port as communication port information.

### CROSS-REFERENCE TO RELATED APPLICATION

This application relates to and claims priority from Japanese Patent Application No. 2005-5988, filed on Jan. 13, 2005, the entire disclosure of which is incorporated by reference.

### BACKGROUND

The present invention relates to an operation management system for diskless computers, and more particularly to a technology for the monitoring of the operating states of the communication ports of a storage system and the allocation of the communication ports to computers that execute prescribed operations in conjunction with such storage system.

In the conventional art, an operating system (OS) and various application programs are stored on a storage device in an individual computer, principally on a hard disk drive (HDD), and are executed on the individual computer. By contrast, a system has recently been proposed that uses so-called diskless computers and a storage system in which the operating system and application programs ordinarily stored on the storage devices on individual computers in the prior art are concentrated in the storage system and the HDD is removed from the individual computers.

In a system using diskless computers and a storage system, because multiple diskless computers access the storage system, management of the relationship between the diskless computers and the logical units (resources) of the storage system is critical, as is management of the communication ports of such storage system.

However, in a conventional system comprising diskless computers and a storage system, these management tasks are not taken into account, and accordingly, a method by which to appropriately manage the relationship between the computers and the logical units (resources) of the storage system, as well as the communication ports of such storage system, has been desired.

### SUMMARY

With the foregoing in view, there is need to improve the management and reliability of communications between the computers and the storage system.

In order to resolve the problem described above, a first aspect of the present invention provides a management computer that manages access by client computers to a storage system that includes multiple communication ports. The management computer pertaining to the first aspect of the present invention comprises a monitoring module that monitors the operating states of the multiple communication ports of the storage system, a storage unit that stores current communication port information regarding the communication port among the multiple communication ports that is allocated to the client computers, as well as port information including information identifying each of the multiple communication ports and information regarding the operating states of the multiple communication ports, and a switching module that, where a change in the operating state of the current communication port is detected by the monitoring module, replaces such current communication port with a different communication port among the multiple communication ports and updates the current communication port information and the port information that are stored on the storage unit.

According to the management computer pertaining to the first aspect of the present invention, because the operating states of the multiple communication ports of the storage system are monitored and where a change in the operating state of the current communication port is detected, the current communication port is replaced by a different communication port among the multiple communication ports and the current communication port information and port information that are stored on the storage unit are updated, the management and reliability of communications between the computers and the storage system can be improved.

A second aspect of the present invention provides a management computer that manages access to a storage system that includes multiple communication ports by function computers that execute prescribed operations with respect to the storage system. The management computer pertaining to the second aspect of the present invention comprises a monitoring module that monitors the operating states of the multiple communication ports of the storage system, a storage unit that stores current communication port information regarding the communication port among the multiple communication ports that is currently allocated to the client computers, as well as port information including information identifying each of the multiple communication ports and information regarding the operating states of the multiple communication ports, and a transmission module that, where it is detected by the monitoring module that all of the multiple communication ports are in a communication-enabled operating state, transmits to the client computers the information identifying the port among the multiple communication ports that has the fewest used resources and the current communication port information that are stored on the storage unit.

According to the management computer pertaining to the second aspect of the present invention, because the operating states of multiple communication ports of the storage system are monitored, and where all of the multiple communication ports are in a communication-enabled state, the information identifying the port among the multiple communication ports that has the fewest used resources and the current communication port information that are stored on the storage unit are transmitted to the client computers, the management and reliability of communications between the computers and the storage system can be improved.

A third aspect of the present invention provides a management computer that manages access by client computers to a storage system that includes a primary communication port and a secondary communication port. The management computer pertaining to the third aspect of the present invention comprises a monitoring module that monitors the operating states of the primary and secondary communication ports of the storage system, a storage unit that stores current communication port information regarding the communication port among the multiple communication ports that is currently allocated to the client computers, as well as port information including the target names and Internet protocol addresses of the primary and secondary communication ports and information regarding the operating states of the primary and secondary communication ports, a current communication port setting module that sets the primary communication port as the initial current communication port and that, where it is detected by the monitoring module that the current communication port is in a communication-disabled state, sets the primary or secondary communication port that is not such current communication port as a new current communication port, a switching module that updates the current communication port information and port information that are stored on the storage unit, and a transmission module that transmits to the client computers the updated current communication port information and port information that are stored on the storage unit.

According to the management computer pertaining to the third aspect of the present invention, because the operating states of the primary and secondary communication ports are monitored, and where it is detected that the current communication port is in a communication-disabled state, the primary or secondary communication port that is not the current communication port is set as a new current communication port, the current communication port information and port information that are stored on the storage unit are updated, and the updated current communication port information and port information are transmitted to the client computers, the management and reliability of communications between the computers and the storage system can be improved.

A fourth aspect of the present invention provides a management computer that manages access by client computers to a storage system that includes multiple communication ports. The management computer pertaining to the fourth aspect of the present invention comprises a monitoring module that monitors the operating states of the multiple communication ports of the storage system, a switching module that, where among the multiple communication ports, a change in the operating state of the communication port that is allocated to the client computers is detected, replaces such communication port with a different communication port among the multiple communication ports, and a notification module that notifies the client computers of the replacement communication port.

According to the management computer pertaining to the fourth aspect of the present invention, because the operating states of the multiple communication ports of the storage system are monitored, and where, among the multiple communication ports, a change is detected in the operating state of the communication port allocated to the client computers, such communication port is replaced by a different communication port among the multiple communication ports, and the client computers are notified of the replacement communication port, the management and reliability of communications between the computers and the storage system can be improved.

A fifth aspect of the present invention provides a client computer that communicates with a storage system that includes multiple communication ports via a communication port allocated thereto by a management computer. The client computer pertaining to the fifth aspect of the present invention comprises a communication module that communicates with the storage system via a communication port allocated thereto by a management computer, and a port switching module that, where a notification regarding a change of communication port is received from the management computer, replaces the communication port that the client computer is currently using with the communication port specified by the notification.

According to the client computer pertaining to the fifth aspect of the present invention, because where a notification regarding a change of communication port is received from the management computer, the communication port that is currently being used is replaced with the communication port specified by the notification, the management and reliability of communications between the computers and the storage system can be improved.

The management computer and the client computer pertaining to the present invention can also be realized in the form of a management method, a communication control method, a management program, a communication control program or a computer-readable recording medium on which such management program or communication control program is recorded.

### BRIEF DESCRIPTION OF THE DRAWINGS

FIG. 1 is an explanatory drawing showing the basic construction of a computer system including a management computer pertaining to this embodiment;

FIG. 2 is a conceptual explanatory drawing showing the internal construction of the management computer pertaining to this embodiment;

FIG. 3 is a conceptual explanatory drawing showing the internal construction of a desktop centric PC pertaining to this embodiment;

FIG. 4 is a drawing showing in a simplified fashion the construction of the software incorporated in the system management server.

FIG. 5 is a drawing showing in a simplified fashion the construction of the software incorporated in the storage devices.

FIG. 6 is a drawing showing in a simplified fashion the construction of the software incorporated in the boot management server;

FIG. 7 is a drawing showing in a simplified fashion the construction of the software incorporated in the authentication server;

FIG. 8 is a drawing showing in a simplified fashion the construction of the software incorporated in the centric PCs;

FIG. 9 is a drawing showing in a simplified fashion the construction of the software incorporated in the installer PC;

FIG. 10 is an explanatory drawing showing an example of information managed by the system management server 10;

FIG. 11 is an explanatory drawing showing the associations between centric PCs and the logical units of the storage devices 20a, 20b, as well as associations between such logical units and logical disks;

FIG. 12 is an explanatory drawing showing an example of information managed by the storage devices 20a, 20b;

FIG. 13 is an explanatory drawing showing an example of information managed by the authentication server 31;

FIG. 14 is a flow chart showing the communication port management routine;

FIG. 15 is an example of a table that is used during determination of a current communication port to be allocated to a centric PC;

FIG. 16 is an example of a table that is used during determination of a current communication port to be allocated to a function server;

FIG. 17 is a flow chart showing the operations of an authentication routine executed at the time of network boot, using the MAC address of a desktop centric PC;

FIG. 18 is a flow chart showing the operations of an authentication routine executed at the time of network boot, using the user ID of a desktop centric PC;

FIG. 19 is a flow chart showing the operations of an authentication routine executed at the time of network boot, using the user ID of a blade centric PC;

FIG. 20 is a flow chart showing the operations of an authentication routine executed when a management program executable only by the administrator is carried out;

FIG. 21 is a flow chart showing the operations of an authentication routine executed when a management program executable by users is carried out;

FIG. 22 is an explanatory drawing showing the system construction involved in the execution of the user registration and storage area allocation routines;

FIG. 23 is a flow chart showing the user registration routine;

FIG. 24 is a flow chart showing the PC registration routine executed when PC information is individually input by a PC registrant;

FIG. 25 is a flow chart showing the PC registration routine by which PC information is automatically registered when the PC registration program is executed;

FIG. 26 is a flow chart showing the iSCSI disk allocation routine;

FIG. 27 is an explanatory drawing showing the system construction involved in the execution of the disk image creation routine;

FIG. 28 is a flow chart showing the processing routine executed when disk images are individually created;

FIG. 29 is a flow chart showing the processing routine executed to create master disk images on which the creation of disk images is based;

FIG. 30 is a flow chart showing the processing routine for the creation of disk images using master disk images;

FIG. 31 is a flow chart showing the processing routine executed when disk images are automatically created;

FIG. 32 is an explanatory drawing showing the system construction involved in the execution of the desktop centric PC 40 boot and shutdown routines;

FIG. 33 is a flow chart showing the desktop centric PC 40 boot routine;

FIG. 34 is a flow chart showing the desktop centric PC 40 shutdown routine executed;

FIG. 35 is an explanatory drawing showing the system construction involved in the execution of the blade centric PC 42 boot and shutdown routines;

FIG. 36 is a flow chart showing the blade centric PC 42 boot routine; and

FIG. 37 is a flow chart showing the blade centric PC 42 shutdown routine.

### DESCRIPTION OF THE PREFERRED EMBODIMENTS

The diskless computer operation management system (management computer and management method) pertaining to the present invention is described below based on an embodiment with reference to the accompanying drawings.

System Construction

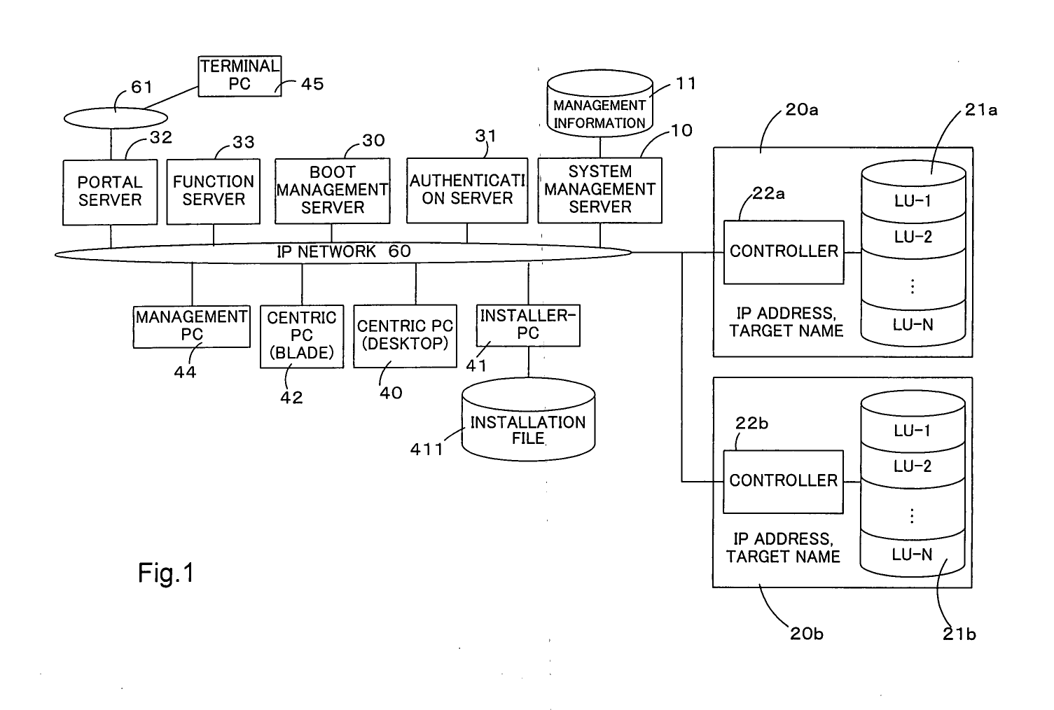

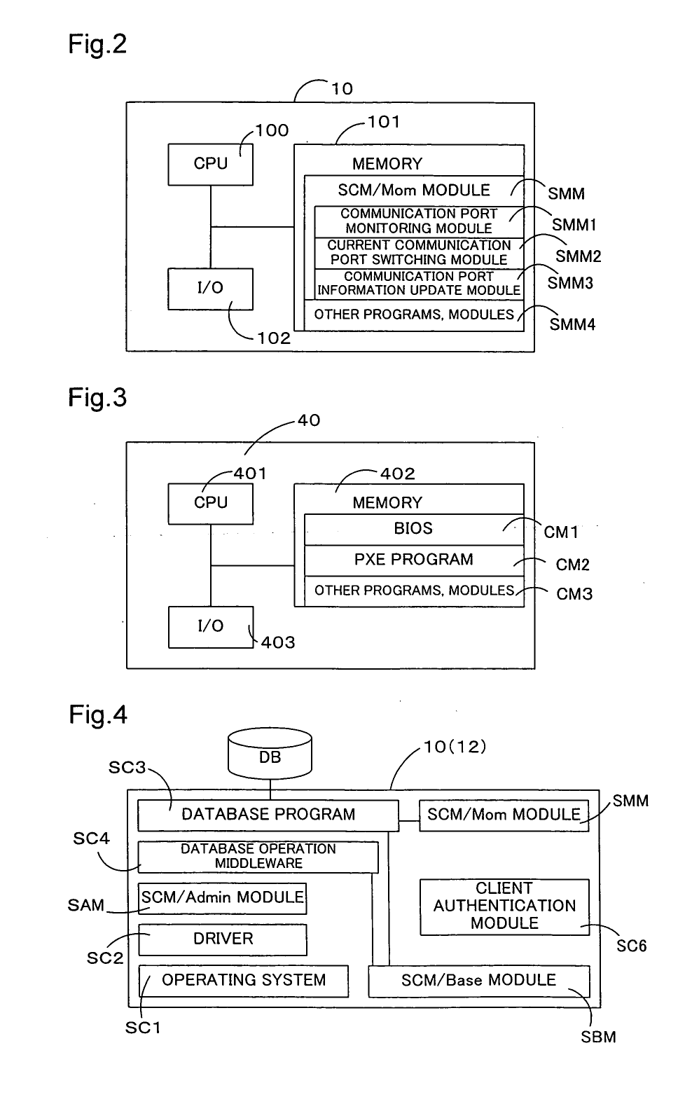

The basic construction of a computer system (storage-centric system) that includes the management computer pertaining to this embodiment is described with reference to FIGS. 1 through 3. FIG. 1 is an explanatory drawing showing the basic construction of a computer system that includes the management computer pertaining to this embodiment. FIG. 2 is a conceptual explanatory drawing showing the internal construction of the management computer. FIG. 3 is a conceptual explanatory drawing showing the internal construction of a desktop centric PC.

The system management server computer 10 (hereinafter ‘system management server’) 10 that serves as the management computer pertaining to this embodiment is connected to a storage device 20 over an IP network 60. The IP network 60 is an Ethernet®-based local area network (LAN), and data is transmitted over this network using the TCP/UDP/IP communication protocol.

Other computers connected to the IP network 60 include a boot management server 30, an authentication server 31, a portal server 32 and function servers 33. Client computers connected to the IP network 60 include one or more desktop centric PCs (hereinafter ‘centric PCs’) 40, an installer PC 41, one or more blade centric PCs (hereinafter ‘blade PCs’) 42 and a management PC 44.

The system management server 10 is a server computer that manages users that use the storage-centric system, the computers used by these users, and the logical units (LU) that store disk images. The system management server 10 is connected to a storage device 11 that stores the various types of management information described below.

The system management server 10 includes internally a CPU 100, a memory 101 and an I/O interface 102, as shown in FIG. 2. The CPU 100, memory 101 and I/O interface 102 are connected to each other via a bus. The CPU 100 is an arithmetic processing unit that executes various programs and modules stored on the memory 101. The memory 101 is a so-called internal storage device that includes a non-volatile memory that stores various modules and the like and a volatile memory that temporarily stores the results of arithmetic processing. The I/O interface 102 is connected to storage devices 20a, 20b via the IP network 60. Needless to say, like the system management server 10, the boot management server 30, authentication server 31 and portal server 32 described below also each include a CPU, memory and I/O interface.

An SCM/Mom module SMM that manages the states of the primary communication ports and secondary communication ports of the storage devices 20a, 20b is stored on the memory 101. The SCM/Mom module SMM includes a communication port monitoring module SMM1 that monitors the states of the primary and secondary communication ports of the storage devices 20a, 20b, a current communication port switching module SMM2 that sets and switches current communication ports, a communication port information update module SMM3 that updates the information regarding the states of the various communication ports stored on the memory 101 or the storage device 11, and a module SMM4 that handles other programs, modules or drivers. The various programs and modules stored on the memory 101 are described below.

The storage devices 20a, 20b are disk array devices comprising multiple magnetic hard disk drives formed in a RAID configuration, and one or more logical units (LU) 21a, 21b are provided by multiple hard disk drives or by one hard disk drive. Access to each logical unit (LU) is executed using a logical unit number (LUN) and a logical block address (LBA). In FIG. 1, two storage devices 20a, 20b are shown, but the number of storage devices may consist of only one, or of three or more. In the example shown in FIG. 1, each storage device 20a, 20b includes multiple logical units LU-1 through LU-N.

The storage devices 20a, 20b transmit and receive data to and from the server computers such as the system management server 20 or the client computers such as the centric PCs 40 using the iSCSI protocol.

Controllers 22a, 22b each house communication ports. An IP address and iSCSI target name are allocated as information to identify each communication port. Controllers 22a, 22b connect a specified logical unit with a server computer or client computer in response to an LU connection request (i.e., a request to connect to a logical unit) from the server computer or client computer. The controllers 22a, 22b also carry out CHAP authentication in response to a CHAP authentication request from a server computer or client computer, or write data (i.e., a file) to a logical unit LU or read out data from a logical unit LU in response to a data write request or data read request.

The boot management server 30 has a function to supply boot information needed in order to execute a network boot of a centric PC 40, i.e., the IP address to be used by the centric PC 40, the IP address of the DHCP server, i.e., the boot management server 30, the name of the boot loader program, and various DHCP options as described below. The boot management server 30 transmits these items of information to the centric PC 40 in response to a PXE program request executed by the BIOS during bootup of the centric PC 40.

The authentication server 31 is a server computer that performs authentication of users who use the storage-centric system of this embodiment. The authentication server 31 executes such user authentication using the LDAP (Lightweight Directory Access Protocol), for example.

The portal server 32 is a server computer that serves as a portal for terminal PCs 45 located outside the IP network 60 to enable them to access the storage-centric system. In order for a terminal PC 45 to use a storage device 20, it must access the portal server 32 over the network 61 and boot a blade PC 42 via the portal server 32. These operations will be described in more detail below.

A centric PC 40 may comprise a computer that lacks an internal storage device such as a hard disk drive, for example, or may comprise an ordinary computer that contains a hard disk drive. However, where the centric PC 40 includes a hard disk drive, after the contents of the hard disk drive are transferred to the storage device 20a or 20b, the hard disk drive is not used when the centric PC 40 is operated, and the centric PC 40 is thereafter used in the same manner as a diskless computer. In other words, the centric PCs 40 used in this embodiment are computers that use a storage device 20a or 20b as a storage device over the network, and may comprise not only diskless computers but also computers that do not require a local storage device during computer operation. While only one centric PC 40 is shown in FIG. 1, two or more centric PCs 40 may be used.

Each centric PC 40 includes a CPU 401 that executes programs and modules, a memory 402 that stores network boot programs and other programs and modules, and an I/O interface 403 that enables communication over the network 60, as shown in FIG. 3. Stored on the memory 402 are a BIOS (CM1) that boots the centric PC 40, a PXE (Preboot eXecution Environment) program CM2 that enables network bootup, a file system module that converts logical addresses to physical addresses and enables access to the storage devices 20a, 20b on an individual file basis, a device management module and iSCSI driver that enable multiple logical units to be handled as a single logical unit, and other programs, modules and drivers. Needless to say, like the centric PC 40, the installer PC 41 and the blade PC 42 also include a CPU, memory and I/O interface.

The installer PC 41 is a computer that installs on the logical units 21a, 21b of the storage devices 20a, 20b disk images of the operating system and application programs. The installer PC 41 includes a storage device 411 that stores files and data to be installed (stored) on the storage devices 20a, 20b. The installer PC 41 is used in order to install on the storage devices 20a, 20b a pre-chosen operating system and application programs, or to install on the storage devices 20a, 20b the operating system and application programs stored on the local disk of a computer before it is used as a centric computer 40. The former case applies to the building of a network boot environment that includes centric PCs 40 using new diskless computers, for example. The latter case applies to the transfer to the storage devices 20a, 20b of disk images of the operating systems and application programs stored on the local disks of existing computers in order to use the existing computers as diskless computers.

A blade PC 42 is a centric PC 40 that includes a remote desktop server function. While only one blade PC 42 is shown in FIG. 1 for purposes of explanation, two or more blade PCs 42 may naturally be used. A terminal PC 45 is a computer that includes, for example, a keyboard or other input device and a display monitor or other display device. A blade PC 42 executes command processes input from the input device of a terminal PC 45 and outputs to the display device of the terminal PC 45 the results of such execution (i.e., the display screen).

The management PC 44 is a computer used by the administrator of the storage-centric system, and is used in order to carry out via the system management server 10 the monitoring, registration and deletion of system resources, i.e., the resources in the storage devices 20a, 20b.

In this embodiment, iSCSI is used as the method for transmitting data over the IP network 60.

Construction of Programs, Modules, Drivers

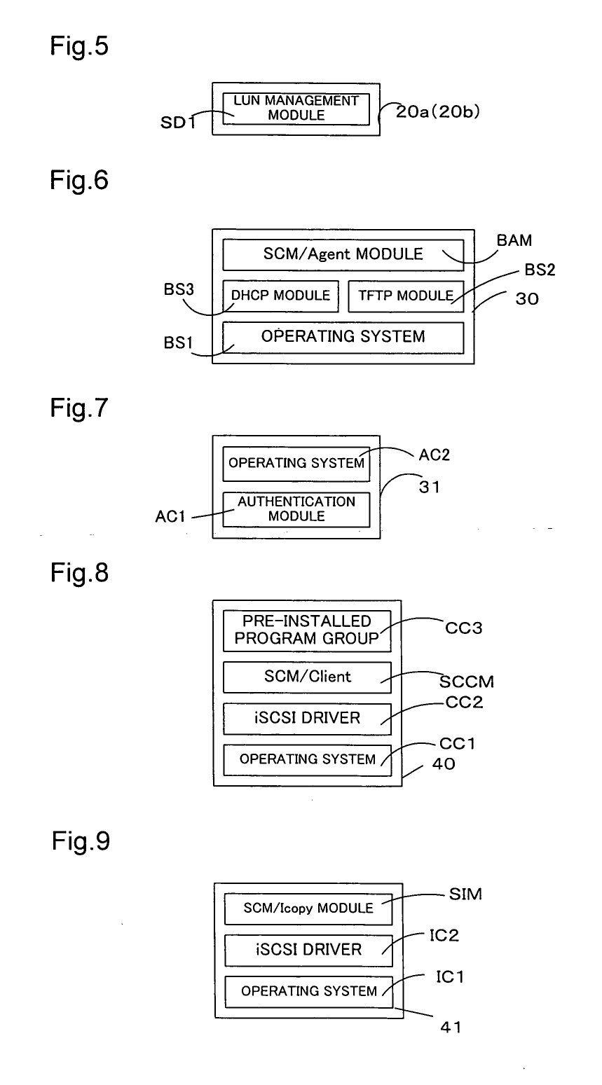

The construction of the programs, modules and drivers incorporated in the system management server 10, the storage devices 20a, 20b, the boot management server 30, the authentication server 31, the centric PCs 40 and the installer PC 41 will now be described with reference to FIGS. 4 through 9. FIG. 4 is a drawing showing in a simplified fashion the construction of software incorporated in the system management server. FIG. 5 is a drawing showing in a simplified fashion the construction of software incorporated in the storage devices. FIG. 6 is a drawing showing in a simplified fashion the construction of software incorporated in the boot management server. FIG. 7 is a drawing showing in a simplified fashion the construction of software incorporated in the authentication server. FIG. 8 is a drawing showing in a simplified fashion the construction of software incorporated in the centric PCs. FIG. 9 is a drawing showing in a simplified fashion the construction of software incorporated in the installer PC.

The construction of software incorporated in the system management server 10 will now be described with reference to FIG. 4. The system management server 10 includes as important modules to execute the storage-centric system an SCM/Base module SBM, an SCM/Mom module SMM and an SCM/Admin module SAM. The system management server 10 also includes as other programs, modules and drivers an OS SC1, a driver SC2, a database program SC3, middleware SC4 used for database operation, a client LUN management module SC5, a client authentication module SC6 and a Web server module.

The SCM/Base module SBM is an execution module that manages the system resources necessary for the functioning of the storage-centric system, and manages, for example, information (i.e., system resources) pertaining to the creation of disk images for the storage devices 20a, 20b and to the bootup and shutdown of the centric PCs 40. The SCM/Mom module SMM is an execution module that manages the states of the primary and secondary communication ports of the storage devices 20a, 20b described above. The SCM/Admin module SAM is an execution module that registers system resources with the system management server 10 and creates the screens used to view the system resources registered in the system management server 10.

The client authentication module SC6 is a module that asks the authentication server 31 to perform authentication in response to a request from a centric PC 40 when the centric PC 40 is booted and receives the authentication result. This client authentication module SC6 could be incorporated in the centric PCs 40, but the centric PCs 40 of this embodiment are diskless computers that can maintain only a limited number of resources. Accordingly, in this embodiment, the client authentication module SC6 is incorporated in the system management server 10, and authentication processing is carried out by having the system management server 10 execute the client authentication module SC6 in response to a request from a centric PC 40.

The construction of the software incorporated in the storage device 20a (20b) will now be described with reference to FIG. 5. The storage device 20a (20b) includes an LUN management module SD1 that manages the logical units (i.e., the logical unit names and numbers) formed in the storage device 20a (20b).

The construction of the software incorporated in the boot management server 30 will now be described with reference to FIG. 6. The boot management server 30 includes an SCM/Agent module BAM, an operating system BS1, a TFTP module BS2 and a DHCP module BS3. The SCM/Agent module BAM is an execution module that implements the creation of DHCP options and the transmission (notification) to the SCM/Base module SBM of the bootup and shutdown of the SCM/Client module SCM. The DHCP options include the current communication port information, primary/secondary communication port information, host information and PC type information described below. The TFTP module BS2 is a module that, in the case of a network boot, implements the TFTP server function to provide a bootstrap program in response to a request from a client computer. The DHCP module BS3 is a module that, in the case of a network boot, implements a DHCP server function to supply, in response to a request from a client computer, boot information required by the client computer for a network boot, i.e., the IP address to be used by the centric PC 40 or blade PC 42, the IP address of the boot management server 30 (i.e., the TFTP module BS2), the name of the boot loader program and the DHCP options. The TFTP module BS2 and the DHCP module BS3 transmit these items of information to the centric PC 40 in response to a request from the PXE program executed by the BIOS when the centric PC 40 is booted.

The construction of the software incorporated in the authentication server 31 will now be described with reference to FIG. 7. The authentication server 31 includes an operating system AS1 and an authentication module AS2. In this embodiment, the authentication module AS2 executes authentication processing between the authentication server 31 and a centric PC 40 or the portal server 32 using the LDAP protocol.

The construction of the software incorporated in the centric PCs 40 (or the blade PCs 42) will now be described with reference to FIG. 7. Each centric PC 40 includes an SCM/Client module SCCM, an operating system CC1, an iSCSI driver CC2, and a pre-installed program group CC3. The SCM/Client module SCCM is a module that notifies the system management server 10 of the bootup and shutdown of a centric PC 40. The iSCSI driver CC2 is software that causes the operating system CC1 to recognize an iSCSI device used for communication with the storage devices 20a, 20b over the iSCSI protocol IP network 60 of this embodiment.

The construction of the software incorporated in the installer PC 41 will now be described with reference to FIG. 9. The installer PC 41 includes an SCM/Icopy module SIM, an operating system IC1, an iSCSI driver IC2 and a client authentication module IC3. The SCM/Icopy module SIM is an execution module that creates disk images for the logical units of the storage devices 20a, 20b. The client authentication module IC3 is an execution module that requests that authentication processing be performed by the authentication module AC2 included in the authentication server 31 and receives the results of such authentication, and adheres to the LDAP protocol.

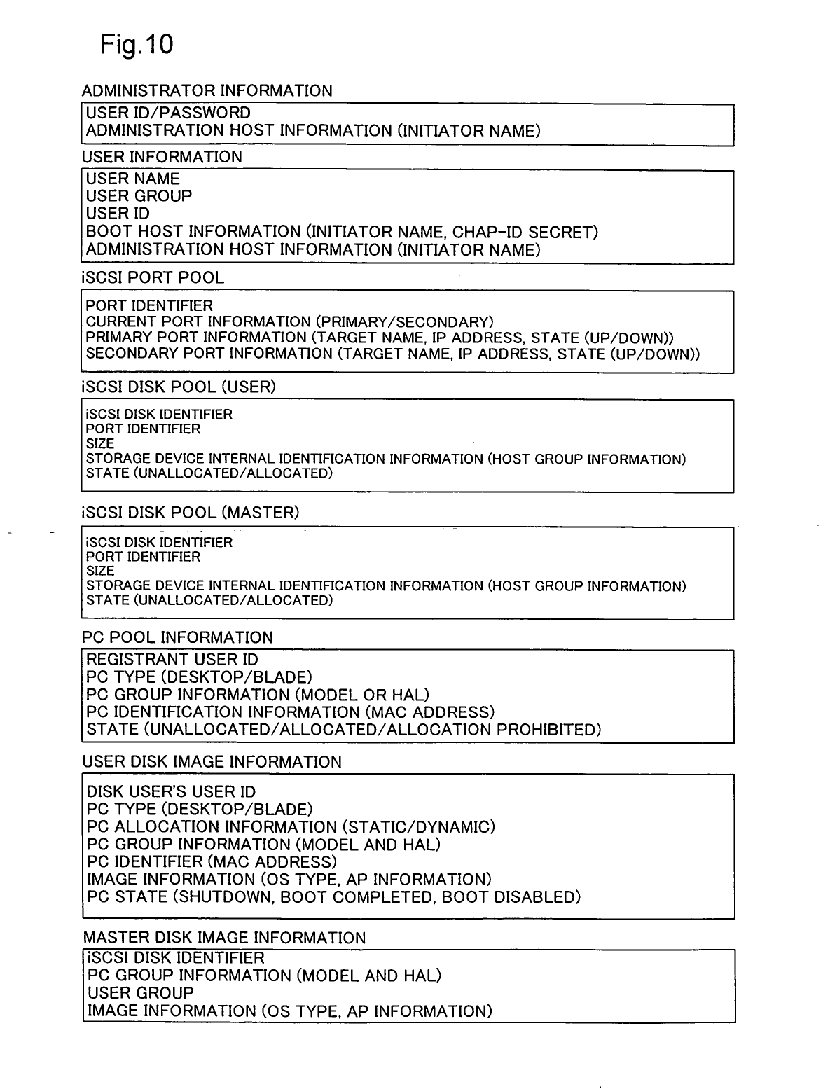

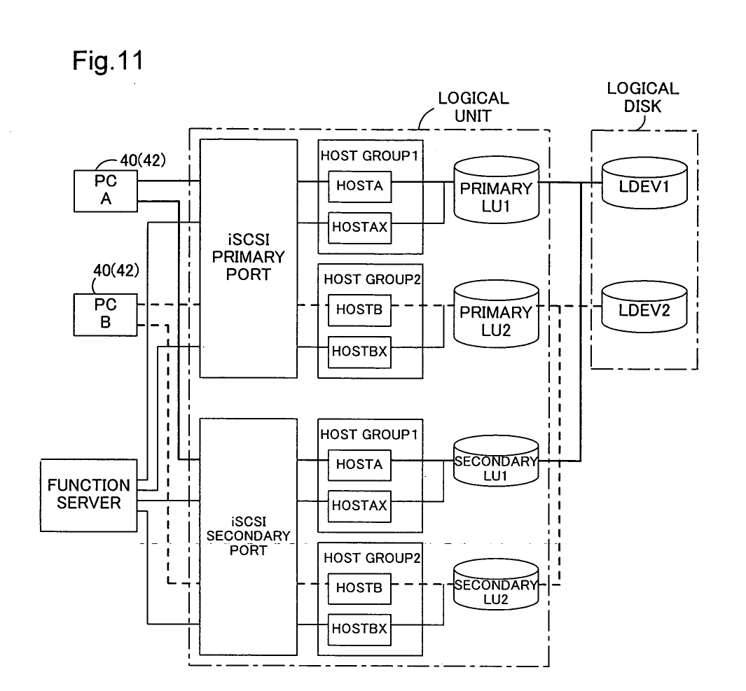

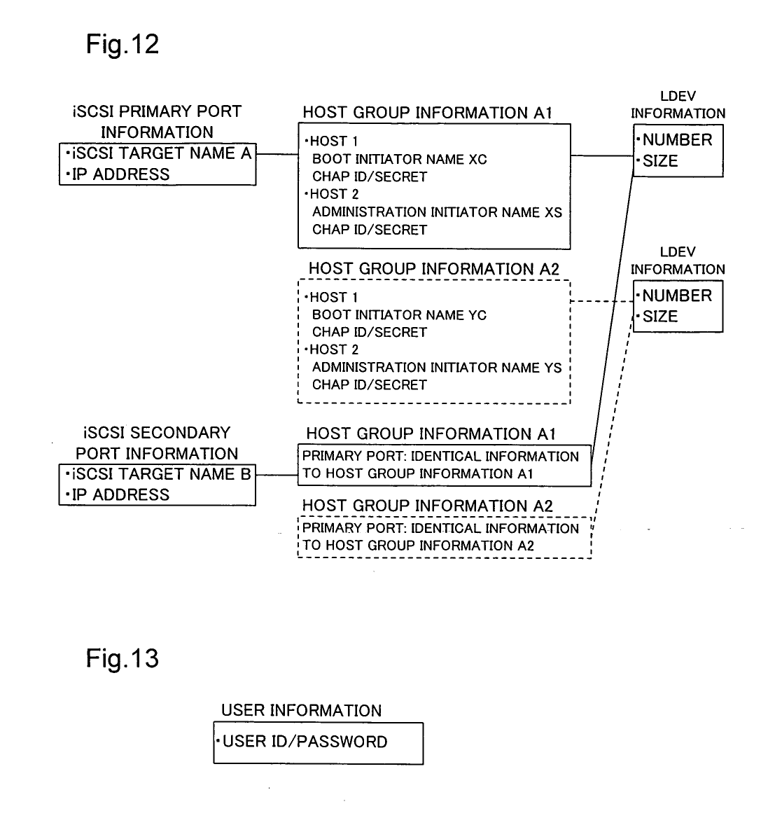

Information managed by the system management server 10 (i.e., system resources), information managed by the storage devices 20a, 20b, and information managed by the authentication server 31 will be described below with reference to FIGS. 10 through 13, respectively. FIG. 10 is an explanatory drawing showing an example of information managed by the system management server 10. FIG. 11 is an explanatory drawing showing the associations between centric PCs and the logical units of the storage devices 20a, 20b, as well as associations between such logical units and logical disks (logical devices). FIG. 12 is an explanatory drawing showing an example of information managed by the storage devices 20a, 20b. FIG. 13 is an explanatory drawing showing an example of information managed by the authentication server 31.

Information managed by the system management server 10 will now be described with reference to FIG. 10.

(1) The user ID and password of the administrator of the storage-centric system and the name of the iSCSI initiator (administration host information) used during creation of master disk images are registered as administrator information.

(2) User information regarding each user who uses the storage-centric system is registered as user information, and includes the user name, the user group comprising the user's job position information, the user's user ID, the iSCSI initiator name comprising boot host information used by the user during bootup, and the iSCSI initiator name comprising administration host information used by the system administrator during backup and virus scanning of the logical unit (iSCSI disk) associated with the user. Where the user is a user using a blade PC 42, the boot host information further includes a CHAP ID and secret.

(3) Information pertaining to the iSCSI ports of the storage devices 20a, 20b used in the storage-centric system is registered in the iSCSI port pool. Specifically, such information includes port identifiers comprising information to identify the pair of a primary communication port and a secondary port, current port information indicating the communication port used by a centric PC 40, and primary and secondary communication port information comprising the target names and IP addresses and information indicating the UP/DOWN state of each port.

(4) iSCSI disk information pertaining to the LDEVs (logical disks) of the storage devices 20a, 20b used in the storage-centric system is registered in the iSCSI disk pool. The iSCSI disk information is registered in connection with each user's disk image storage area and the master disk image storage area, respectively. The information in the iSCSI disk pool includes identifiers by which to identify iSCSI disks within the system management server 10, port identifiers by which to identify iSCSI communication ports, values indicating the size of each iSCSI disk (logical unit), storage device internal identification information comprising information used to identify iSCSI disks within the storage devices 20a, 20b, and state information comprising information indicating whether each iSCSI disk has been allocated to a user.

(5) Information regarding the centric PCs is registered in the PC pool. The information included in the PC pool includes registrant user IDs comprising identification information regarding users that registered a centric PC, PC group information specifying the PC type, model or HAL (computer hardware property), which indicates whether each registered centric PC is a desktop computer (centric PC 40) or a blade computer (blade PC 42), PC identification information indicating the MAC address of each registered computer, and state information indicating whether or not each registered centric computer has been allocated to user disk images and whether allocation is prohibited due to failure or other reason.

(6) Information regarding iSCSI disks allocated to users, as well as centric PC information, are registered in the user disk image information. Specifically, such information includes disk user IDs, iSCSI disk identifiers and the PC type information and PC identification information regarding the centric PC of each user. Where the PC type indicates a blade PC, information indicating whether or not the method of PC allocation is dynamic or static (PC allocation information) and PC group information are also included. The PC group information is information used when the method of allocation is dynamic and is used as a condition for PC selection. The user disk image information also includes image information that indicates the operating system and application program information that is registered when disk images are created. Furthermore, the user disk image information includes the IP address for each centric PC that is supplied to the system management server 10 after bootup of a centric PC, and PC state information comprising information regarding the state of each centric PC, i.e., whether a centric PC is operating, not operating, or prohibited from bootup.

(7) Information regarding disk images used as a master is registered in the master disk image information. Specifically, such information includes the identifier for the iSCSI disk on which the master disk images are stored, PC group information indicating the PC type and HAL that can be booted using the master disk images, the user group information indicating the users that can use the master disk images and image information indicating the information regarding the operating system and application programs registered as the master disk images.

Information managed by the storage device 20a (20b) will now be described with reference to FIGS. 11 and 12. First, with reference to FIG. 11, the relationships among centric PCs 40, logical disks, logical units and iSCSI primary and secondary ports will be described. In the storage device 20a (20b), a iSCSI communication port and an iSCSI target have a one-to-one correspondence. One iSCSI communication port is shared by multiple centric PCs. For the identification of virtual iSCSI logical units accessed by centric PCs that share a communication port, a LUN security function, i.e., the function that executes access control with respect to a logical unit using the iSCSI initiator name of each centric PC, is used. In this embodiment, in order to increase the reliability and availability of the storage-centric system, the iSCSI communication ports are made redundant, i.e., two iSCSI communication ports are provided, but the number of ports is not limited to two, and three or more ports may be provided instead.

Two logical units LU comprising a primary LU and a secondary LU are allocated to a centric PC 40 (blade PC 42) as iSCSI logical units. The primary and secondary logical units are virtual iSCSI storage areas, and are mapped on the same logical disk LDEV. A construction in which the primary and secondary logical units are mapped on different logical disks LDEV may also be used, but in this embodiment, an example in which they are mapped on the same LDEV will be described.

In the example shown In FIG. 11, a host group 1 and a host group 2 that respectively correspond to a PC ‘A’ and a PC ‘B’ are registered with each iSCSI communication port. Logical units 1 that correspond to a logical disk LDEV 1 are allocated to the host group 1 while logical units LU2 that correspond to a logical disk LDEV 2 are allocated to the host group 2. Furthermore, the host groups registered with the primary communication port are allocated to the primary logical units LU, while the host groups registered with the secondary communication port are allocated to the secondary logical units LU. Each host group comprises a host (host A or host B) that corresponds to each centric PC, and a host (host AX or BX) that corresponds to the function server.

The function server (backup server PC or virus scan server PC) can be connected to the logical units for any centric PC 40 (42).

Information managed by the storage device 20a (20b) will now be described with reference to FIG. 12. Such information includes iSCSI communication port information, host group information and LDEV information.

The iSCSI communication information is information by which to specify an iSCSI communication port of the storage device 20a (20b). It is available for both the primary and secondary communication ports, and includes the iSCSI target name and IP address of the logical disk LDEV associated with each iSCSI communication port. The host group information is information by which to specify a host group regarding the storage device 20a (20b), and includes centric PC 40 host information and function server host information. The same information is registered as host group information for the primary communication port and as host group information for the secondary communication port. The host group information includes two items of host information. One (host information 1) is information by which to identify a centric PC 40 (42) and the other (host information 2) is information by which to identify a function server. The host information 1 comprises a boot initiator name (XC, YC) by which to identify the bootstrap and iSCSI driver, as well as a CHAP_ID and secret. The host information 2 comprises an administration initiator name (XS, YS) by which to identify the backup server or virus scan server as well as a CHAP_IDs and secret.

The logical disk LDEV information includes the number by which to identify each logical disk and the storage capacity information therefor. The system management server 10 determines which of the primary and secondary communication ports will be used, and the port determined for use is deemed the current port.

Information managed by the authentication server 31 will now be described with reference to FIG. 12. The authentication server 31 contains a user ID and password for each user as user information.

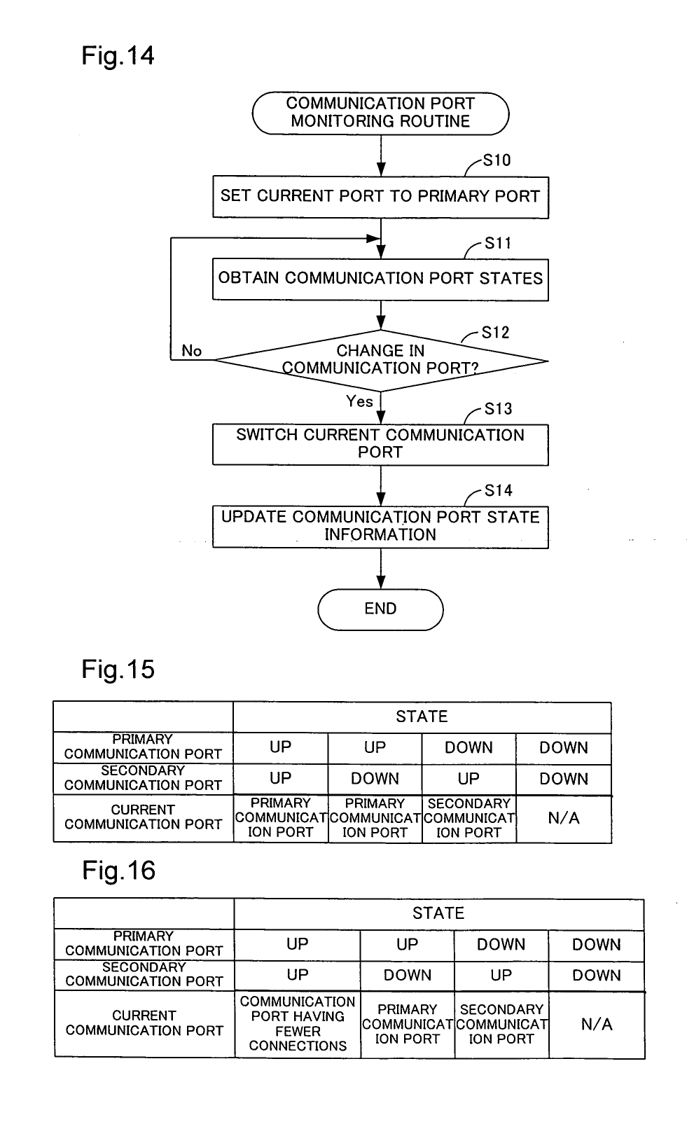

The communication port management process executed in this embodiment will be described with reference to FIGS. 14 through 16. FIG. 14 is a flow chart showing the communication port management routine. FIG. 15 is an example of a table that is used during determination of a current communication port to be allocated to a centric PC. FIG. 16 is an example of a table that is used during determination of a current communication port to be allocated to a function server.

This processing routine is executed by the SCM/Mom module SMM included in the system management server 10. More specifically, it is executed by the communication port monitoring module SMM1, current communication port switching module SMM2 and communication port information update module SMM3 that comprise the SCM/Mom module SMM.

When this processing routine begins, the current communication port switching module SMM2 sets the primary communication port as the current communication port (step S10). In other words, in this embodiment, the default current communication port is the primary communication port. The communication port monitoring module SMM1 obtains communication port state data (step S11) and determines whether or not a change has occurred in the states of the communication ports (step S12). The communication port monitoring module SMM1 obtains the communication port state data by pinging the primary communication port and the secondary communication port. The communication port states are determined based on whether a response was received from the respective communication ports.

Where it is determined that there has been no change in the states of the communication ports (NO in step S12), the communication port monitoring module SMM1 continues to monitor the communication ports. Where the communication port monitoring module SMM1 determines that there has been a change in the state of a communication port (YES in step S12), on the other hand, the current communication port switching module SMM2 changes the setting of the current communication port (step S13).

Specifically, a change in the state of a communication port means that a communication port in the UP state (communication-enabled state) in which it responds to pinging changes to the DOWN state (communication-disabled state) in which it does not respond to pinging, and vice versa. The current communication port switching module SMM2 changes the setting of the current communication port based on the table shown in FIG. 15. In other words:

(1) Where both the primary and secondary communication ports are in the UP state (for example, where the secondary communication port is the current communication port and the primary communication port has changed from the DOWN state to the UP state), the primary communication port is set as the current communication port;

(2) Where the primary communication port is in the UP state and the secondary communication port is in the DOWN state (for example, where the secondary communication port is the current communication port, and the primary communication port has changed from the DOWN state to the UP state), the primary communication port is set as the current communication port;

(3) Where the primary communication port is in the DOWN state and the secondary communication port is in the UP state (for example, where the primary communication port is the current communication port, and the primary communication port has changed from the UP state to the DOWN state), the secondary communication port is set as the current communication port; and

(4) Where both the primary and secondary communication ports are in the DOWN state (for example, where the primary communication port is the current communication port and the primary communication port has changed from the UP state to the DOWN state), neither of the communication ports is set as the current communication port.

(5) Where the primary communication port is in the UP state, no change is made to the current communication port setting even if the state of the secondary communication port changes.

After a change is made to the current communication port setting, the communication port information update module SMM3 updates the communication port information, i.e., the iSCSI port pool information described above (step S14), whereupon the processing routine ends. The iSCSI port pool information includes current communication port information, the states of each communication port and the target names and IP addresses of the primary and secondary communication ports.

The iSCSI port pool information is supplied to the boot management server 30, installer PC 41 and function servers as iSCSI disk information. Where both the primary and secondary communication ports are in the UP state, the current port information and the target names and IP addresses of the primary and secondary communication ports are supplied as the iSCSI disk information. Where only one of the communication ports is in the UP state, the current port information and the target name and IP address of the communication port in the UP state are supplied as the iSCSI disk information. Where both the primary and secondary communication ports are in the DOWN state, no information is supplied.

Where a current communication port is to be allocated to a function server, such current communication port allocation may be carried out in the manner shown in FIG. 16. In other words, where both the primary and secondary communication ports are in the UP state (for example, where the secondary communication port is the current communication port and the primary communication port has changed from the DOWN state to the UP state), the communication port having fewer connections is set as the current communication port. The current communication port is set in the same manner as described in connection with FIG. 15 in the following cases, and therefore no further explanation will be given therefor:
Where the primary communication port is in the UP state and the secondary communication port is in the DOWN state;
Where the primary communication port is in the DOWN state and the secondary communication port is in the UP state; or
Where both the primary and secondary communication ports are in the DOWN state.
   Authentication

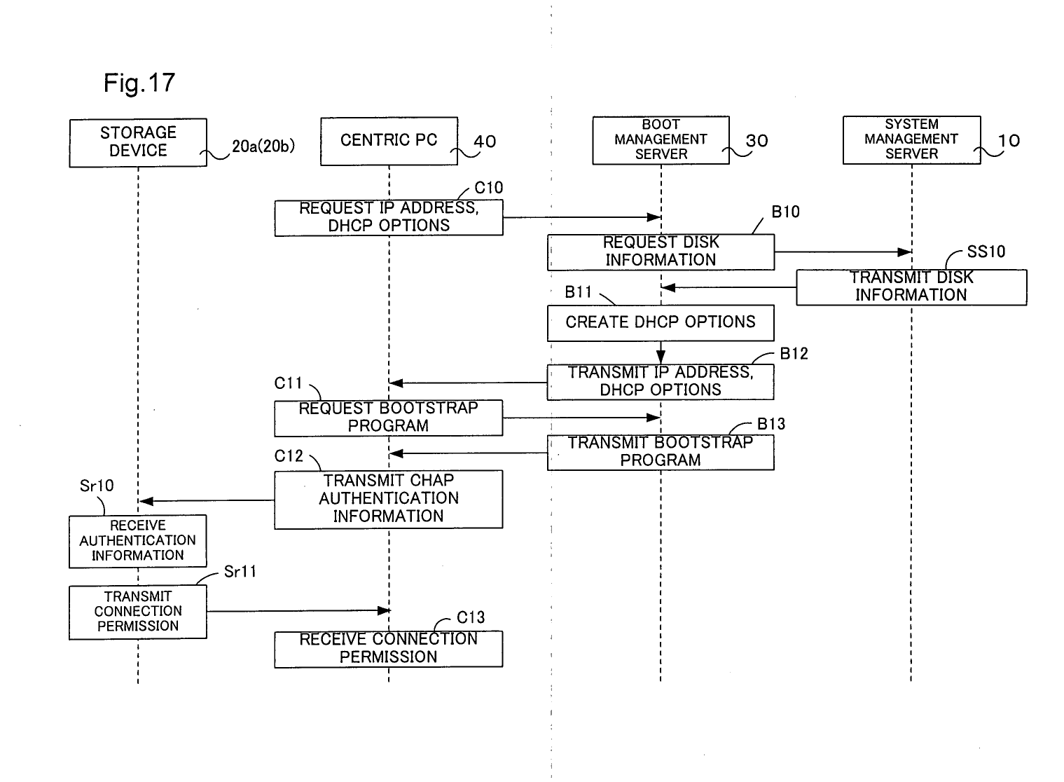

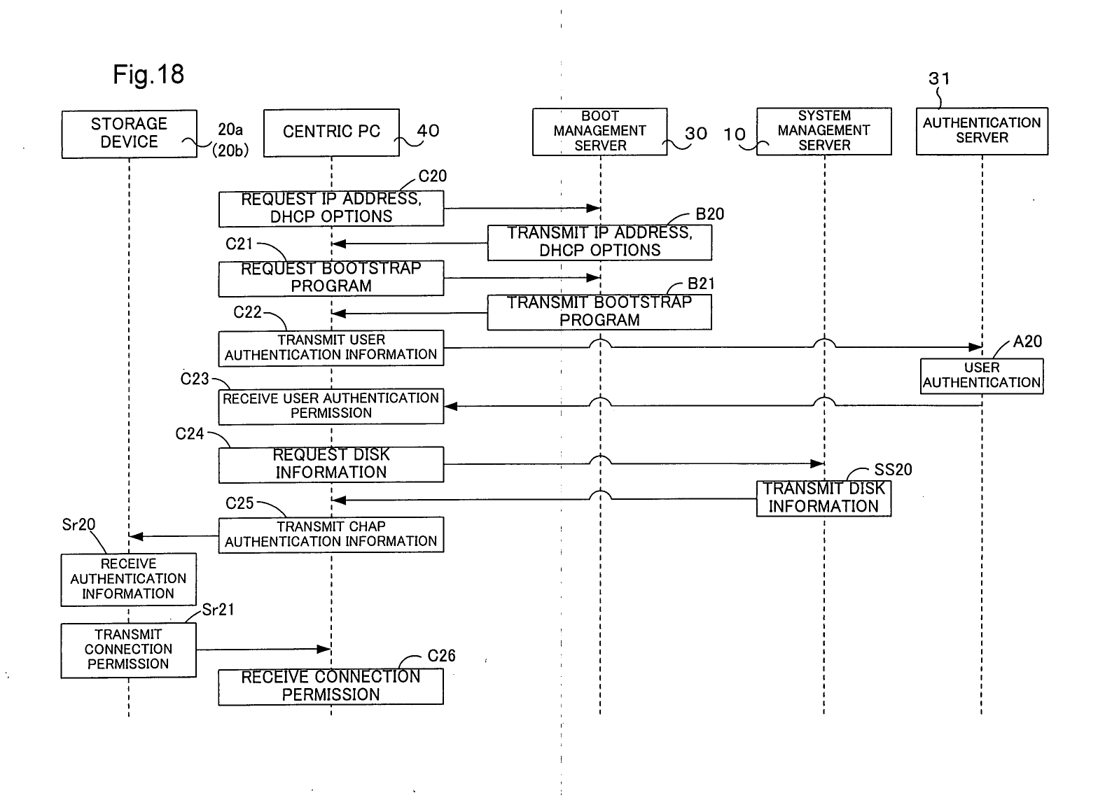

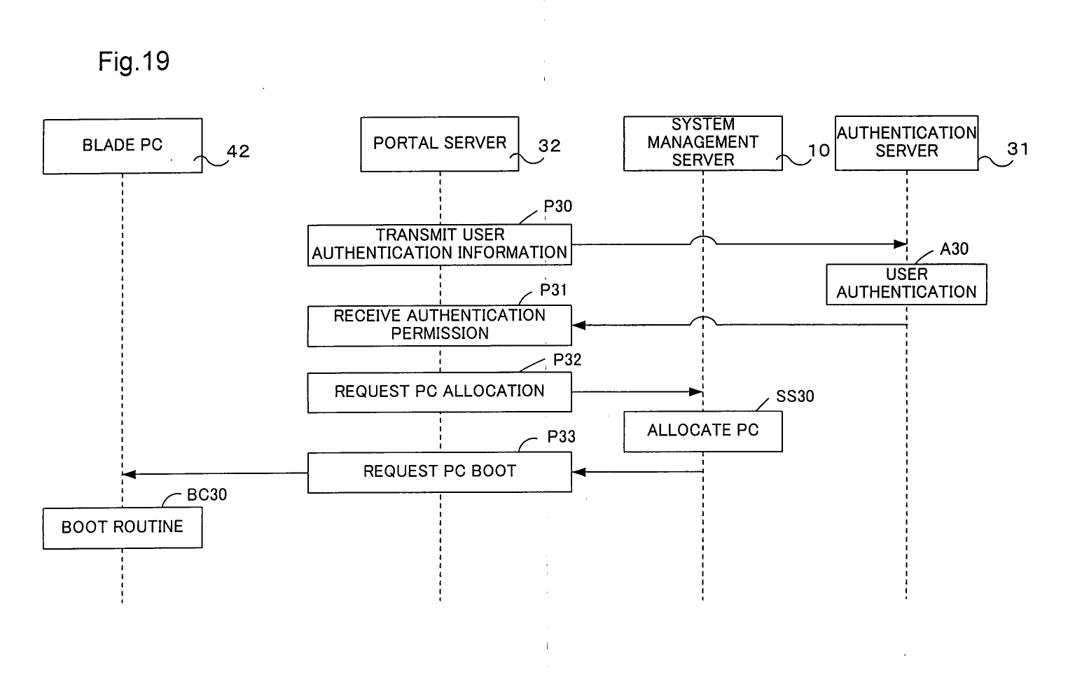

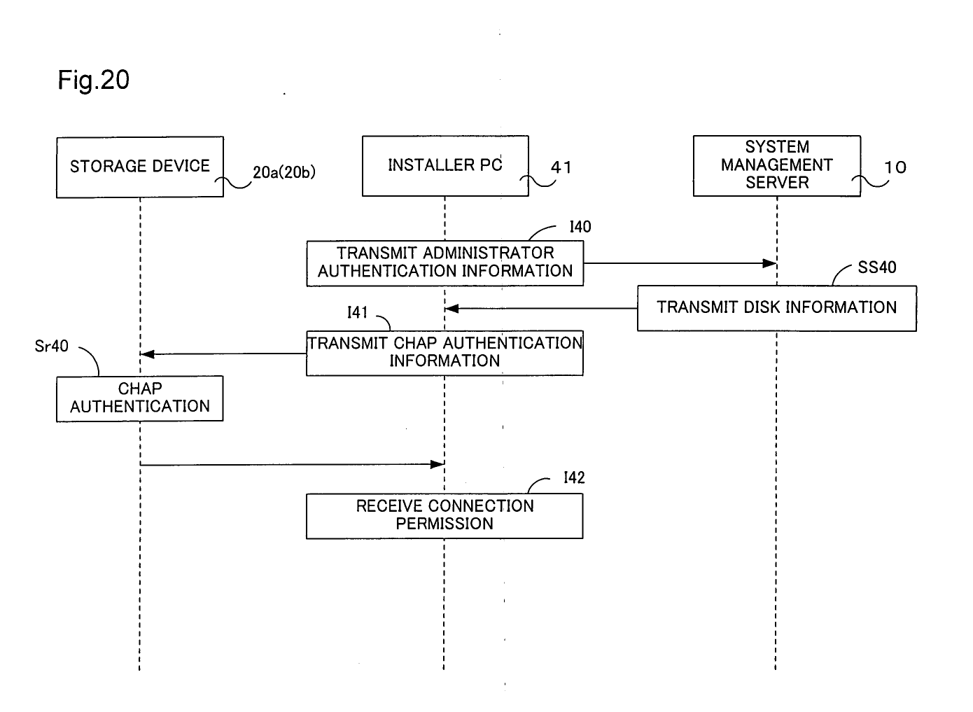

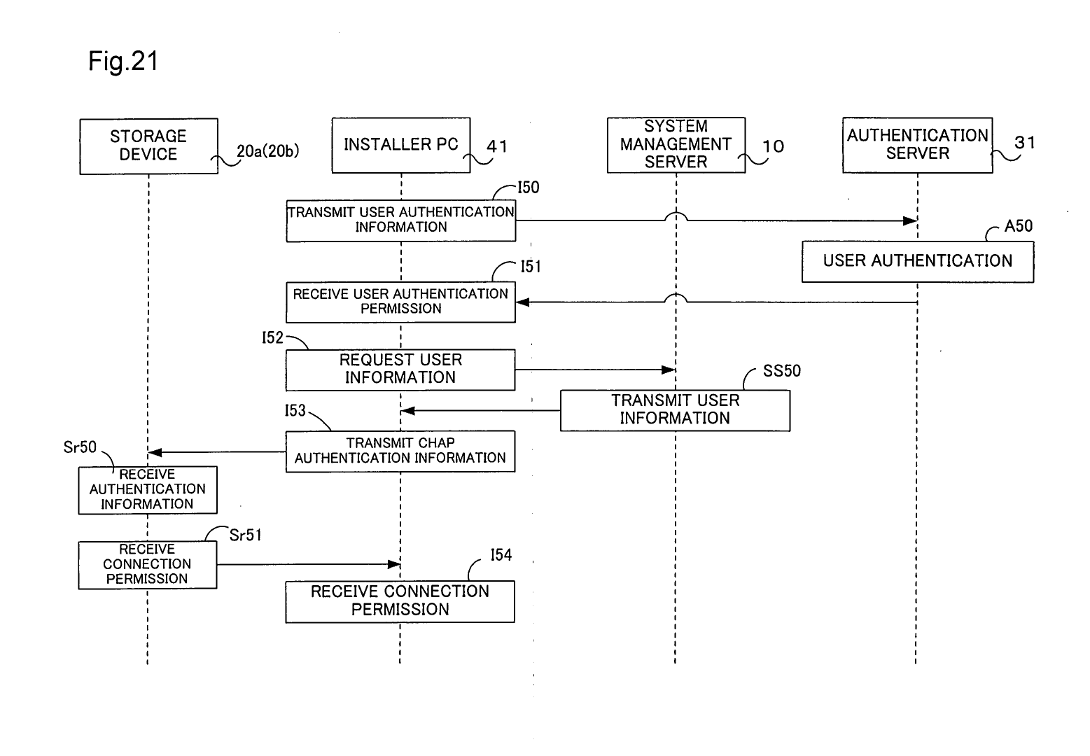

The authentication processes executed in the storage-centric system of this embodiment will now be described with reference to FIGS. 17 through 21. FIG. 17 is a flow chart showing the operations of an authentication routine executed at the time of network boot, using the MAC address of a desktop centric PC. FIG. 18 is a flow chart showing the operations of an authentication routine executed at the time of network boot, using the user ID of a desktop centric PC. FIG. 19 is a flow chart showing the operations of an authentication routine executed at the time of network boot, using the user ID of a blade centric PC. FIG. 20 is a flow chart showing the operations of an authentication routine executed when a management program executable only by the administrator is executed. FIG. 21 is a flow chart showing the operations of an authentication routine executed when a management program executable by users is executed.

Authentication executed in the storage-centric system of this embodiment includes user authentication and administrator authentication. User authentication is executed in the following cases:
At the time of bootup of a centric PC (desktop centric PC 40 or blade centric PC 42); or
When a user uses a management program (such as the disk image creation program).

The authentication server 31 is used for user authentication. The user IDs and passwords of the users who employ network bootup are registered with the authentication server 31. The user IDs registered with the authentication server 31 are identical to the storage-centric system user IDs and CHAP user IDs. The user passwords registered with the authentication server 31 are identical to the CHAP secrets.

Administrator authentication is carried out when the administrator uses a management program for the storage-centric system, such as the disk image creation program or the backup program.

The system management server 10 is used for administrator authentication, and the administrator's user ID and password are registered with the system management server 10. It is not necessary for the administrator's user ID to be identical to the administrator's CHAP user ID or for the administrator's password to be identical to the administrator's CHAP secret.

Where the centric PC is a desktop machine, a method exists by which the storage device 20a (20b) to which the PC is to be connected is specified using the MAC address of the centric PC, as well as a method by which such storage device 20a (20b) is specified via user authentication. In the description below, the user ID and password are identical to the CHAP user ID and secret.

The operations of an authentication routine executed at the time of network boot, using the MAC address of a desktop centric PC, will now be described with reference to FIG. 17. When the centric PC 40 is booted, the PXE program sends the MAC address to the DHCP module of the boot management server 30 and requests an IP address and DHCP options therefrom (C10). Upon receiving the request from the centric PC 40, the boot management server 30 requests from the system management server 10 disk information that corresponds to the MAC address received from the centric PC 40 (B10). Upon receiving the request from the boot management server 30, the system management server 10 uses the user information to specify the disk information corresponding to the MAC address, and sends the disk information to the boot management server 30 (SS10). The sent disk information includes the storage device 20a (20b) port address and initiator name.

The boot management server 30 creates DHCP options using the user information received from the system management server 10 (B11). The DHCP options include the IP address to be used by the centric PC as well as the IP address of the boot management server (DHCP server).

Having created the DHCP options, the boot management server 30 sends the centric PC 40 the created DHCP options and the IP address to be allocated to the centric PC 40 (B11). Using the TFTP module location information included in the DHCP options, the centric PC 40 accesses the TFTP module of the boot management server 30 and requests a bootstrap program (C11). The boot management server 30 sends the bootstrap program to the IP address of the centric PC 40 (B13). Upon receiving the bootstrap program, the centric PC 40 boots the bootstrap program, and awaits input of the user ID and password, which equals CHAP authentication information, by the user.

When the user ID and password are input by the user, the bootstrap program sends the input user ID and password to the storage device 20a (20b) having the target name and port address included in the DHCP options as CHAP authentication information (C12). At this stage, communications between the centric PC 40 and the storage device 20a (20b) are carried out by the bootstrap program.

Upon receiving the CHAP authentication information (Sr10), the storage device 20a (20b) determines whether or not CHAP authentication information matching the received CHAP authentication information exists in the host group information, and where CHAP authentication information matching the received CHAP authentication exists in the host group information, i.e., where authentication is successful, the storage device 20a (20b) sends a connection permitted notification to the centric PC 40 (Sr11). Upon receiving the connection permitted notification (C13), the centric PC 40 sequentially executes bootup of the operating system and application programs. Communication between the centric PC 40 and the storage device 20a (20b) after the operating system is booted is implemented via the iSCSI driver and network driver.

The operations of an authentication routine executed at the time of network boot, using the user ID of a desktop centric PC, will now be described with reference to FIG. 18. When the centric PC 40 is booted, the PXE program sends the MAC address to the DHCP module of the boot management server 30, and requests an IP address and DHCP options therefrom (C20). Upon receiving the request from the centric PC 40, the boot management server 30 sends the centric PC 40 the IP address to be allocated thereto and the IP address comprising a DHCP option by which to specify the location of the TFTP module (B20).

Using the TFTP module IP address thus obtained, the centric PC 40 requests a bootstrap program from the TFTP module of the boot management server 30 (C21). The boot management server 30 sends the bootstrap program to the IP address of the centric PC 40 (B21).

Upon receiving the bootstrap program, the centric PC 40 boots the program and awaits user input of the user ID and password, which are equivalent to CHAP authentication information.

When the user ID and password are input by the user, the bootstrap program sends them to the authentication server 31 as user authentication information (C22). Upon receiving the user authentication information, the authentication server 31 executes user authentication (A20), and sends the result thereof to the centric PC 40. Here, user authentication is executed by determining whether or not the user authentication information pre-registered with the authentication server 31 includes user authentication information matching the user authentication information sent from the centric PC 40. In the example shown in FIG. 18, because the bootstrap program includes LDAP client functions, the centric PC 40 can directly ask the authentication server 31 to perform authentication without involving the system management server 10.

Upon receiving a user authentication permitted notification (C23), the centric PC 40 requests disk information from the system management server 10 (C24). The system management server 10 uses the pre-registered user information to specify user information matching the user ID, and sends to the centric PC 40 as the disk information by which to specify the initiator name and current communication port (SS20).

The centric PC 40 sends the input user ID and password to the storage device 20a (20b) having the target name and port address included in the DHCP options (C25). At this stage, communications between the centric PC 40 and the storage device 20a (20b) are implemented by the bootstrap program.

Upon receiving the CHAP authentication information (Sr20), the storage device 20a (20b) determines whether or not CHAP authentication information matching the received CHAP authentication information exists in the host group information, and where CHAP authentication information matching the received CHAP authentication exists in the host group information, i.e., where authentication is successful, the storage device 20a (20b) sends a connection permitted notification to the centric PC 40 (Sr21). CHAP authentication may be executed by the authentication server 31 if cooperation with the authentication server 31 is available.

Upon receiving the connection permitted notification (C26), the centric PC 40 sequentially executes bootup of the operating system and application programs. Communication between the centric PC 40 and the storage device 20a (20b) after the operating system is booted is executed via the iSCSI driver and network driver.

The operations of an authentication routine executed in a blade centric PC at the time of network boot will now be described with reference to FIG. 19. The network boot process using a blade PC 42 is executed when a terminal PC outside the storage-centric system requests that it be allowed to use the storage-centric system.

When user authentication information is input from a terminal PC, the portal server 32 sends the user authentication information to the authentication server 31 (P30). The portal server 32 executes user authentication by comparing the received user authentication information and the user authentication information pre-registered therewith (A30), and if user authentication is successful, the portal server 32 sends an authentication permitted notification to the portal server 32. Upon receiving the authentication permitted notification (P31), the portal server 32 sends a centric PC (blade PC 42) allocation request to the system management server 10 (step S32).

The system management server 10 allocates to the terminal PC a pre-allocated blade PC 42 or a blade PC 42 designated by the user (SS30), and notifies the portal server 32 of such allocation. The allocation is carried out by supplying the MAC address of a blade PC 42, for example. Upon receiving allocation of a blade PC 42, the portal server 32 sends a boot request to the allocated blade PC 42 (P33), which executes the bootup process described with reference to FIG. 17 (BC30). In this case, because user information is already input via the terminal PC, the input of user information after the bootup of the bootstrap program in FIG. 17 is not necessary.

The operations of an authentication routine executed when a management program executable only by the administrator is executed will now be described with reference to FIG. 20. Management programs executable by the administrator only include, for example, the backup program and the disk image creation program. A situation in which the disk image creation program is executed is used as an example in the following description.

When user authentication information is input by the administrator, the installer PC 41 sends the input user authentication information to the system management server 10 via the network driver as administrator authentication information (140). Upon receiving the user authentication information, the system management server 10 uses the pre-registered administrator information to determine whether or not administrator information (comprising an administrator ID and password) matching the received user information exists. Where administrator information matching the received user authentication information is registered, the system management server 10 refers to the user information corresponding to the MAC address of the installer PC 41, obtains disk information including the administrator initiator name and communication port information, and sends it to the installer PC 41. (SS40).

When CHAP authentication information is input, the installer PC 41 sends the input CHAP authentication information via the iSCSI driver and network driver to the communication port of the storage device specified by the disk information (I41). Upon receiving the CHAP authentication information, the storage device 20a (20b) executes CHAP authentication using the host group information pre-registered therewith (Sr40), and if authentication is successful, sends a connection permitted notification to the installer PC 41.

Upon receiving the connection permitted notification (I42), the installer PC 41 copies the disk images stored on the storage device 411 to the storage device 20a (20b).

The operations of an authentication routine executed when a management program executable by users is executed will now be described with reference to FIG. 21. Management programs executable by users include, for example, the disk image creation program. A situation in which the disk image creation program is executed is used as an example in the following description.

The installer PC 41 sends the user authentication information input by the user to the authentication server 31 via the network driver (I50). The authentication server 31 executes user authentication using the user authentication information pre-registered therewith (A50), and if authentication is successful, sends a user authentication permitted notification to the installer PC 41.

Upon receiving the user authentication permitted notification (I51), the installer PC 41 requests disk information from the system management server 10 (I52). The system management server 10 refers to the user information corresponding to the MAC address of the installer PC 41, obtains disk information including the user initiator name and communication port information, and sends it to the installer PC 41 (SS50).

When CHAP authentication information is input, the installer PC 41 sends the input CHAP authentication information via the iSCSI driver and network driver to the communication port of the storage device specified by the disk information (I41). Upon receiving the CHAP authentication information, the storage device 20a (20b) executes CHAP authentication using the host group information pre-registered therewith (Sr40), and if authentication is successful, sends a connection permitted notification to the installer PC 41.

Upon receiving the connection permitted notification (I42), the installer PC 41 copies the disk images stored on the storage device 411 to the storage device 20a (20b).

User Registration

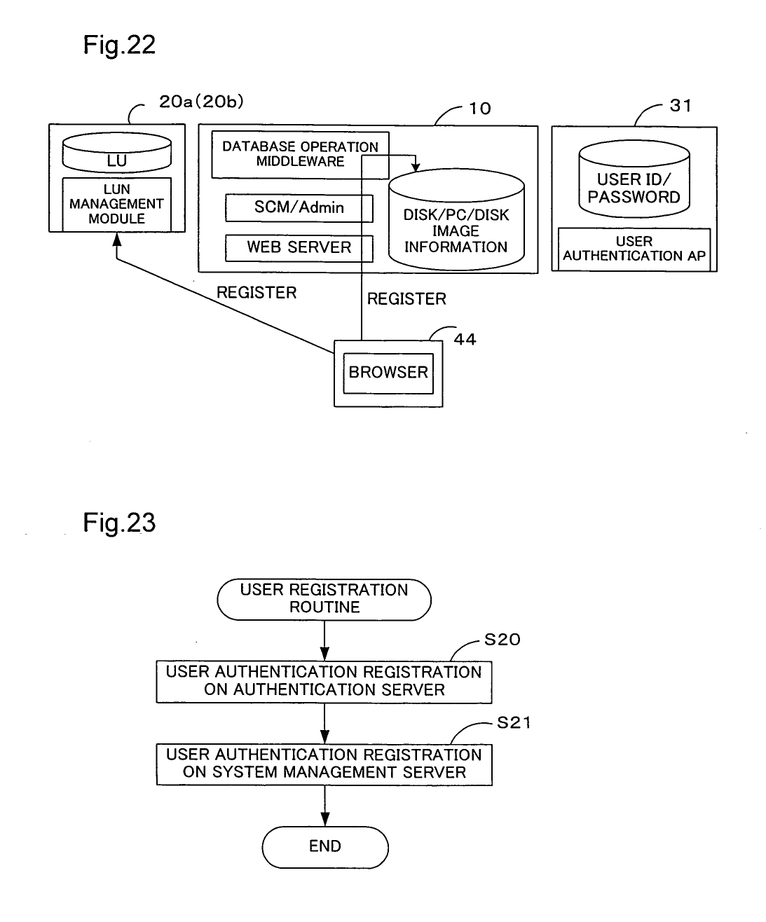

The user registration process will now be described with reference to FIGS. 22 and 23. FIG. 22 is an explanatory drawing showing the system construction involved in the execution of the user registration and storage area allocation routines. FIG. 23 is a flow chart showing the user registration routine.

As shown in FIG. 22, the user registration and storage area allocation routines are executed by the management PC 44. More specifically, they are implemented based on the execution of input processing using a browser program that is booted on the management PC 44 for various browser base services provided by the Web server of the system management server 10. The Web server, SCM/Admin module SAM and database operation middleware SC4 are executed on the system management server 10, and the LUN management module SD1 is executed on the storage device 20a (20b).

The user registration routine will now be described with reference to FIG. 23. The user registration routine is a process by which to register user information with the system management server 10 and user authentication information with the authentication server 31, and is executed by the system administrator. The management PC 45 registers user authentication information with the authentication server 31 (step S20). Specifically, the management PC 45 sends to the authentication server 31 as user authentication information the input user ID and password of a user who is to become a registrant of the centric PC. Upon receiving the user authentication information, the authentication server 31 executes a user authentication application program and registers the received user ID and password in its storage device.

The management PC 45 executes user information registration with the system management server 10 (step S21) and ends this processing routine. Specifically, the management PC 45 registers in the user information the input user name, user ID and user group of a storage-centric system user. The management PC 45 allocates a boot initiator name and management initiator name to the user, and registers them in the user information. Where the centric PC is a blade PC, the management PC 45 registers CHAP authentication information in the user information.

PC Registration

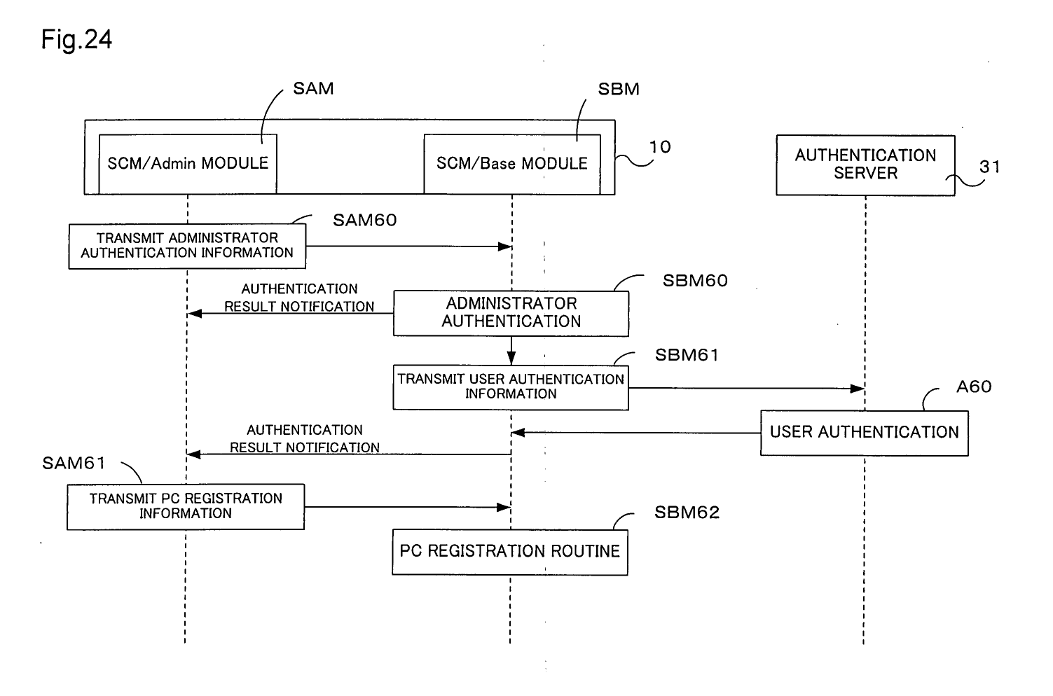

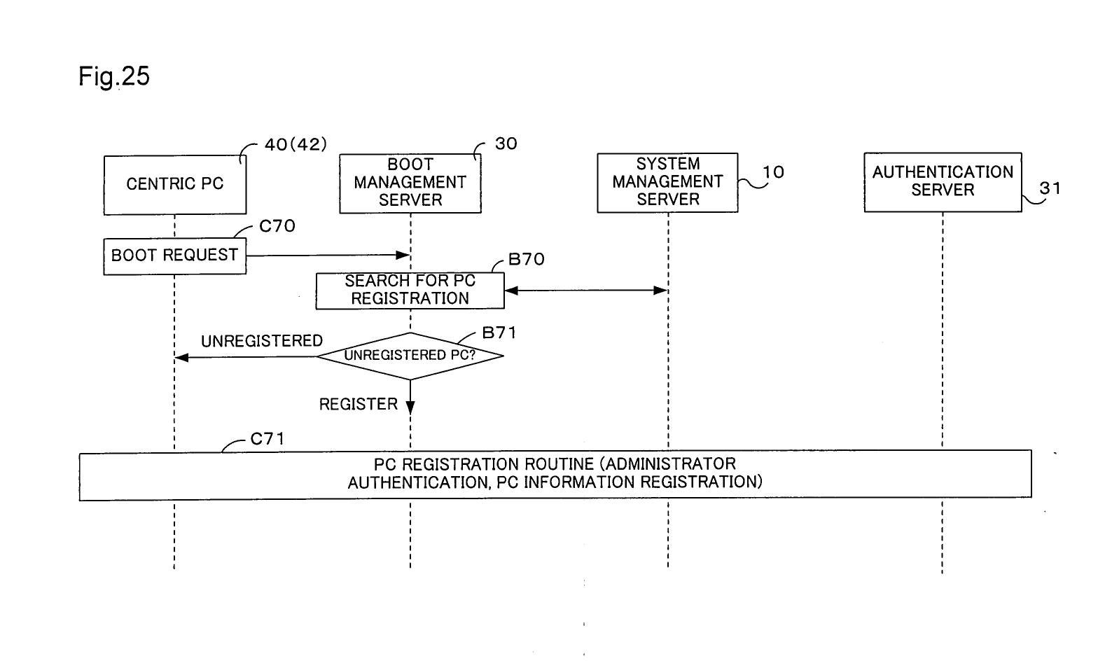

The PC registration routine will now be described with reference to FIGS. 24 and 25. The PC registration routine is executed by the administrator of a centric PC, i.e., by the system administrator or by a user. In the description 20 provided below, the administrator of a centric PC is referred to as a PC registrant.

FIG. 24 is a flow chart showing the PC registration routine executed when PC information is individually input by a PC registrant. FIG. 25 is a flow chart showing the PC registration routine by which PC information is automatically registered when the PC registration program is executed.

The individual PC registration routine will now be described with reference to FIG. 24. This registration routine is executed when a PC registrant executes a management program (SCM/Admin module SAM).

The SCM/Admin module SAM sends the administrator authentication information input by the PC registrant to the SCM/Base module SBM (SAM 60). The SCM/Base module SBM executes administrator authentication using the received administrator information and the administrator information pre-registered therein (SBM 60), and sends the authentication result to the SCM/Admin module SAM. In other words, it is determined by the system management server 10 whether or not the user inputting the administrator information has the authority of a PC registrant.

The SCM/Base module SBM sends the administrator authentication information to the authentication server 31 as user authentication information (SBM 61). Upon receiving the user authentication information, the authentication server 31 executes user authentication using the user authentication information pre-registered therewith and the received user authentication information (A60), and sends the authentication result to the SCM/Base module SBM. The SCM/Base module SBM sends the received authentication result to the SCM/Admin module SAM.

Where administrator authentication and user authentication are successful, the PC registrant can execute PC registration. When the user inputs PC registration information, the SCM/Admin module SAM sends the input PC registration information to the SCM/Base module SBM (Sam 61). The SCM/Base module SBM executes PC registration using the received PC registration information (SBM 62). This PC registration routine is repeatedly executed for the number of centric PCs 40 (42) that require registration.

The information input as PC registration information is the MAC address and model of each centric PC 40 (42). The input PC registration information is stored on the PC pool in association with the registrant's user ID, i.e., the user ID included in the administrator authentication information input first.

The automatic PC registration routine will now be described with reference to FIG. 25. This automatic PC registration routine is executed by obtaining the PC registration program from the boot management server 30 and having it executed. A centric PC 40 (42) sends a boot request including its MAC address to the boot management server 30 (C70). The boot management server 30 (SCM/Agent module BAM) sends the received MAC address to the system management server 10 (SCM/Base module SBM) and requests a PC registration search (B70). Where a centric PC that corresponds to the received MAC address does not exist (B71: unregistered), the boot management server 30 executes the TFTP module and sends the PC registration program to the centric PC 40 (42). On the other hand, where a centric PC that corresponds to the received MAC address exists (B71: registered), the boot management server 30 distributes the bootstrap program for bootup described below and ends this processing routine.

The PC registration program downloaded to the centric PC 40 (42) executes the administrator authentication routine and PC information registration routine described with reference to FIG. 24. As a result, the centric PC 40 (42) is registered in the PC pool of the system management server 10 in association with the administrator authentication information.

iSCSI Disk Allocation

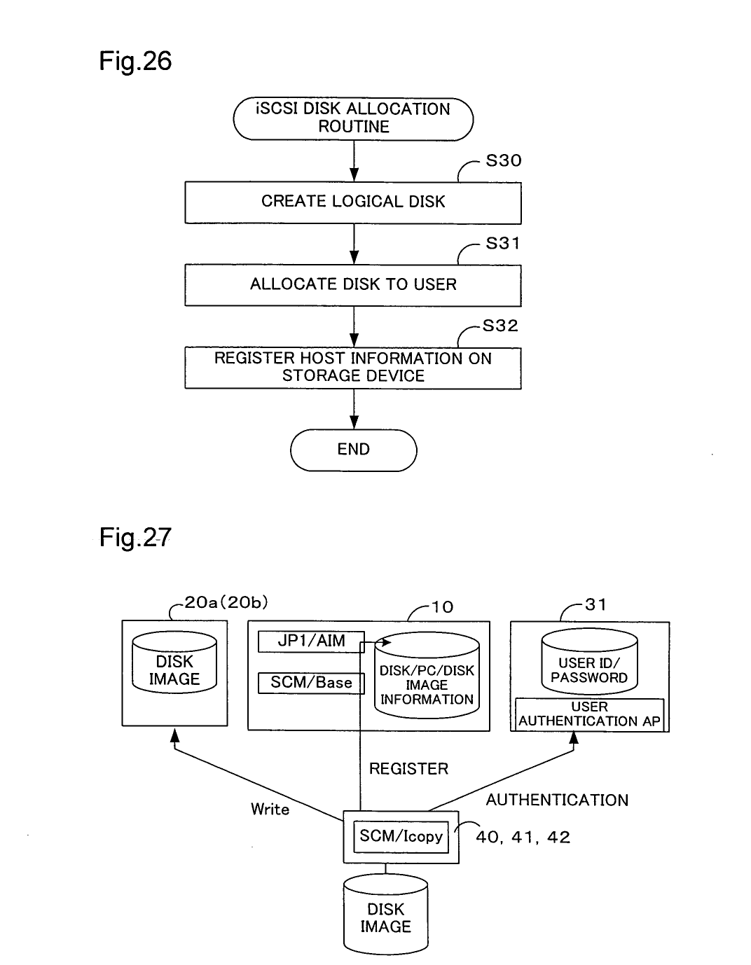

The iSCSI disk allocation routine will now be described with reference to FIG. 26. FIG. 26 is a flow chart showing the iSCSI disk allocation routine. The iSCSI disk allocation routine is executed by the system administrator. It is a process to create (define) a logical disk in the storage device 20a (20b), register the information regarding the created logical disk in the system management server 10, and register host information in the storage device 20a (20b).

The management PC 45 uses the LUN management module SD1 of the storage device 20a (20b) to create a new logical disk (LDEV) and host group and carry out mapping (step S30). The management PC 45 then registers via the SCM/Admin module SAM of the system management server 10 information by which to identify the new logical disk, i.e., port information and disk information, to the system management server 10 in the iSCSI port pool and iSCSI disk pool thereof. Where the logical disk (LDEV) is to be used to store the master disk images, administration host information (initiator name) and CHAP authentication information are registered via the LUN management module SD1 of the storage device 20a (20b).

The management PC 45 executes the routine to allocate a disk to the user via the SCM/Admin module SAM of the system management server 10 (step S31). Specifically, the management PC 45 creates user disk image information and registers the user ID of the disk user the management PC 45 then searches for unallocated disks from the iSCSI disk pool and registers one of the disk identifiers found as a result of the search.

The management PC 45 registers the host information in the storage device 20a (20b) via the LUN management module SD1 thereof (step S32). In other words, it registers the initiator name and CHAP authentication information in the logical disk allocated to the user. Specifically, the management PC 45 newly registers two items of host information in the host group information in the storage device 20a (20b). As the host information 1, the bootstrap and the iSCSI initiator name of the centric PC are registered, and as the host information 2, the iSCSI initiator name of the system management server 10 is registered. As described above, the host information 1 and the host information 2 in the host group information are mapped on the same logical unit LU.

Disk Image Creation

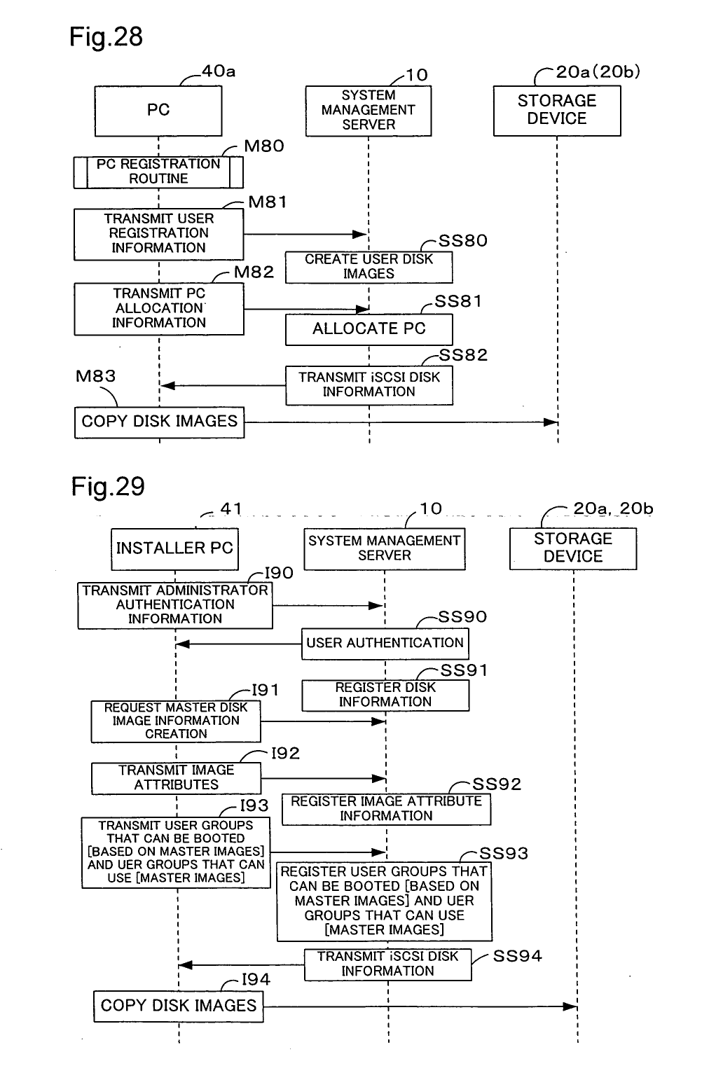

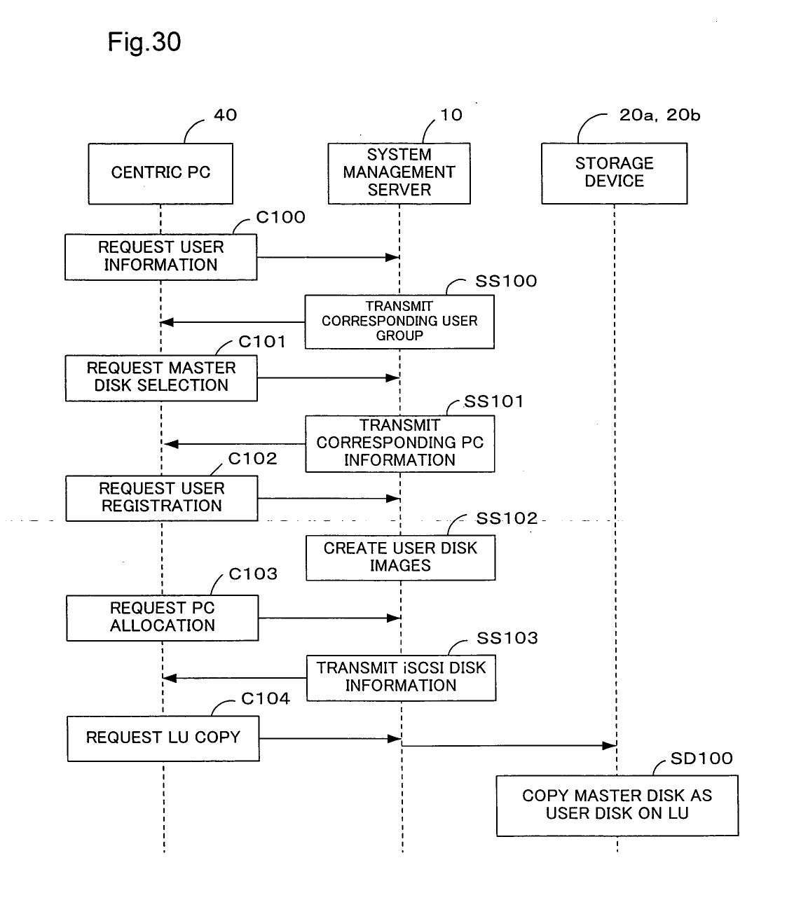

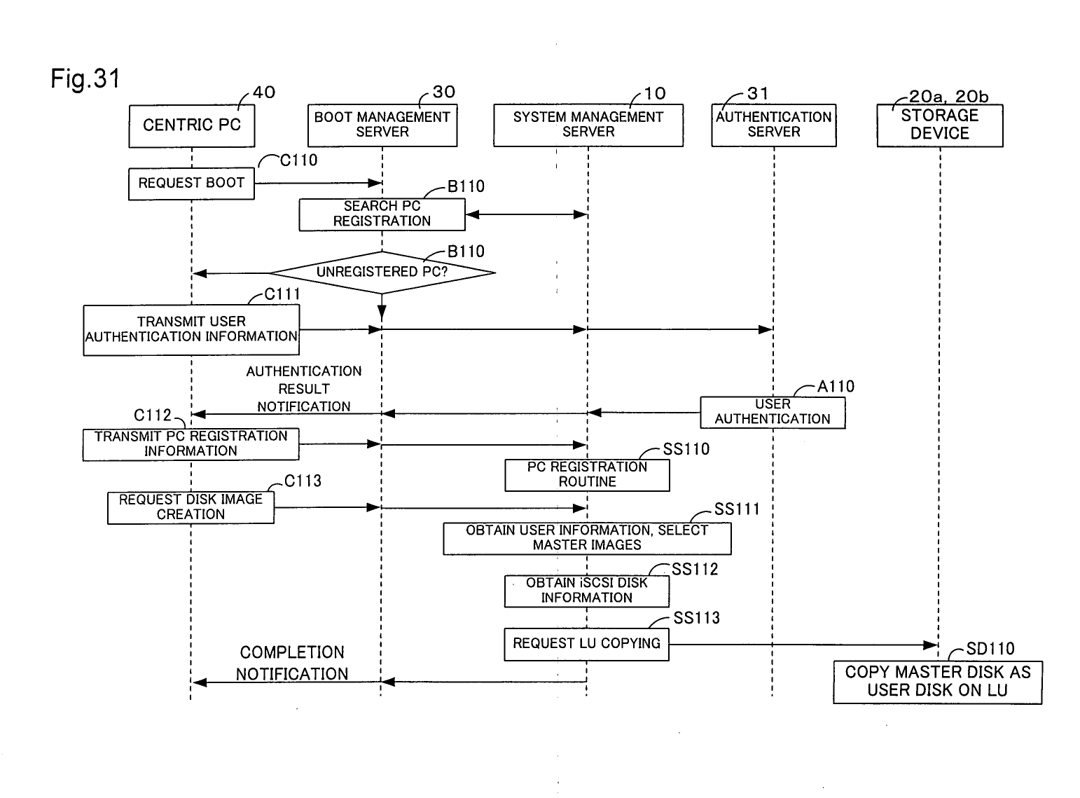

The disk image creation routine will now be described with reference to FIGS. 27 through 31. FIG. 27 is an explanatory drawing showing the system construction involved in the execution of the disk image creation routine. FIG. 28 is a flow chart showing the processing routine executed when disk images are individually created. FIG. 29 is a flow chart showing the processing routine executed to create master disk images on which the creation of disk images is based. FIG. 30 is a flow chart showing the processing routine for the creation of disk images using master disk images. FIG. 31 is a flow chart showing the processing routine executed when disk images are automatically created.

The system construction involved in the execution of the disk image creation routine will now be described with reference to FIG. 27. The disk image creation routine is executed by the SCM/Icopy module SIM included in the installer PC 41 or centric PC 40 (42). In general, because disk image creation is executed following PC individual or automatic registration, authentication is already completed, but where image creation is executed at a different time from PC individual or automatic registration, the administrator authentication routine described above is executed between the PC 41 (40, 42) and the authentication server 31. The PC 41 (40, 42) registers disk image information in the system management server 10, and stores the disk images formed on the local disk of the PC 41 (40, 42) in the storage device 20a (20b). A situation in which a desktop centric PC 40 is used is described as an example.

The situation in which disk images are individually created will now be described with reference to FIG. 28. As a condition for this process, it is assumed that disk images for the operating system and application programs are created on the local disk of the PC 40a, which is used as the centric PC 40, and an iSCSI driver and SCM/Icopy module SIM are installed thereon.

The PC 40a (SCM/Icopy module SIM) executes in advance the PC registration routine described with reference to FIGS. 24 and 26 (M80) to register itself in the system management server 10. The PC 40a sends the user ID to the system management server 10 (SCM/Base module SBM) to register it as disk user information (M81). The system management server 10 searches for the user disk image information using the received user ID (SS80).

The PC 40a then registers the PC type, PC allocation method and PC group information in the user disk image information. The PC allocation method is registered in the case where the PC used by the user when using the user disk images is a blade PC 42. These items of information are input in the system management server 10 by the administrator or user via the PC 40a.

The PC 40a sends the PC allocation information including the PC registrant ID input by the administrator or user to the system management server 10 (M82). The system management server 10 performs PC allocation to the user disk images based on the received PC allocation information (SS81). Specifically, where the centric PC to be allocated to the logical disk (i.e., the PC 40a) is a desktop centric PC 40 or blade centric PC 42 and the PC allocation method is ‘static’, an unallocated PC having a matching PC registrant ID, PC group and PC type is selected from the PC pool. The MAC address of the selected PC is registered in the user disk image information. By contrast, where the centric PC to be allocated to the logical disk is a blade centric PC 42 and the PC allocation method is ‘dynamic’, no PCs to be allocated are registered.

In response to a request from the PC 40a, the system management server 10 sends to the PC 40a iSCSI disk information including the current communication information and boot host information (SS82). The PC 40a copies the disk images formed on the local disk to the storage device 20a (20b) using the received iSCSI disk information (M83). When copying is completed normally, the PC 40a registers image information in the user disk image information.

Where disk images are created for multiple PCs at the same time, the above routine is repeatedly executed.

The master disk image creation routine in the master disk image distribution process will now be described with reference to FIG. 29. In this process, it is assumed that the operating system is installed and disk images thereof are formed on the local disk of one PC, such as the installer PC 41, for example, and furthermore, an iSCSI driver and SCM/Icopy module SIM are installed on the local disk of the installer PC 41.

The installer PC 41 (SCM/Icopy module SIM) sends administrator authentication information to the system management server 10 (I90). The system management server 10 (SCM/Base module SBM) executes the administrator authentication routine using the administrator ID and password pre-registered therewith (SS90), and sends the authentication result to the installer PC 41. If the authentication is successful, the installer PC 41 asks the system management server 10 to create master disk image information (191). Specifically, the system management server 10 creates the master disk image information shown in FIG. 10. First, the logical disk information (communication port identifier) by which to identify the logical disk on which the disk images are to be stored is registered in the master disk image information (SS91). The target logical disk is a logical disk among the logical disks registered in the master iSCSI disk pool whose ‘state’ is indicated as ‘unallocated’, and the communication port identifier for such logical disk and the administration host information registered in the administrator information are registered as logical disk (iSCSI disk) information.

The installer PC 41 sends to the system management server 10 image attribute information that indicates the attributes of the disk images (I92). The system management server 10 registers the received image attribute information in the master disk image information (SS92). The installer PC 41 further sends the system management server 10 information indicating the PC groups that can be booted using the master disk images and information indicating user groups that can use the master disk images (I93). The system management server 10 registers the received such PC group and user group information in the master disk image information as information on PC groups that can be booted using the master disk images and information on user groups that can use the master disk images, respectively (SS93). Where there is a match between a PC model registered in the master disk image information and the model of the PC used by a user, as well as between a user group registered in the master disk image information and the user group to which the user belongs, the user can use the master disk images.

In response to a request from the installer PC 41, the system management server 10 sends to the installer PC 41 iSCSI disk information including the current communication port information and administration host information (SS94). The installer PC 41 copies the master disk images formed on the local disk to the storage device 20a (20b) using the received iSCSI disk information.

The user disk image creation routine will now be described with reference to FIG. 30. The installer PC 41 (SCM/Icopy module SIM) sends the user ID of the user to the system management server 10 (SCM/Base module SBM) and requests user information therefrom (I100). The system management server 10 searches for the user group information that corresponds to the received user ID and sends it to the installer PC 42 as user information (SS100).

Upon receiving the user group information, the installer PC 41 sends it to the system management server 10 and requests selection of a master disk (I110). Upon receiving the user group information, the system management server 10, based on the master disk image information, selects master disk images that can be used by the user group indicated by the received user group information, and sends to the installer PC 41 the iSCSI disk information for the logical disk on which the selected master disk images are stored (SS101).

The PC type, PC allocation method and PC group information are then registered in connection with the user disk image information. The PC allocation method is registered when the PC used by the user when using the user disk images is a blade PC 42. These items of information are input in the system management server 10 by the administrator via the installer PC 41.

The installer PC 41 sends to the system management server 10 the PC allocation information input by the administrator, which includes the PC registrant ID, and requests allocation of a PC (I103). Based on the received PC allocation information, the system management server 10 allocates a PC for the user disk images. Specifically, where the centric PC to be allocated to the logical disk is a desktop centric PC 40 or a blade centric PC 42 and the PC allocation method is ‘static’, an unallocated PC having a matching PC registrant ID, PC group and PC type is selected from the PC pool. The MAC address of the selected PC is registered in the user disk information. In contrast, where the centric PC to be allocated to the logical disk is a blade centric PC 42 and the PC allocation method is ‘dynamic’, no PCs to be allocated are registered.

In response to the request from the installer PC 41, the system management server 10 sends thereto iSCSI disk information including the current communication port information and boot host information (SS103). The installer PC 41 sends the received iSCSI disk information for master disk images as well as iSCSI disk information for user disk images to the system management server 10, and sends a request to the storage device 20a (20b) asking that the master disk images be copied as user disk images (I104). The storage device 20a (20b) specifies the logical disk on which the master disk images are stored based on the master disk image iSCSI disk information, specifies the logical disk on which the user disk images should be stored based on the user disk image iSCSI disk information, and copies the master disk images to the logical disk on which the user disk images are to be stored (SD100).

The disk image automatic creation routine will now be described with reference to FIG. 31. In this processing routine, operations from the registration of a PC in the system management server 10 to the registration of disk images are automatically executed.

A centric PC 40 (42) sends a boot request including its MAC address to the boot management server 30 (C110). The boot management server 30 (SCM/Agent module BAM) sends the received MAC address to the system management server 10 (SCM/Base module SBM), and requests a PC registration search (B110). Where no centric PCs that correspond to the received MAC address are registered (B111: unregistered), the boot management server 30 executes the TFTP module and sends a disk image registration program to the centric PC 40 (42). This disk image registration program executes both PC registration and disk image registration. At the same time, because the boot management server 30 need only execute the disk image creation routine described above, where a centric PC corresponding to the received MAC address is already registered (B111: registered), it distributes the bootstrap program for bootup described below and ends this routine.

The disk image registration program downloaded to the centric PC 40 (42) and the system management server 10 execute administrator authentication and PC information registration described with reference to FIG. 25 (C112, SS110). As a result, the centric PC 40 (42) becomes registered in the PC pool in the system management server 10 in association with administrator authentication information. Where model information is to be registered, the user (who is carrying out the registration) inputs the model information in the system management server 10 via the centric PC 40 (42).

The centric PC 40 (42) (disk image registration program) then executes the user disk image creation routine described with reference to FIG. 30. In other words, the centric PC 40 sends to the system management server 10 the user ID of the user and a user disk image creation request (C113). The system management server 10 identifies the user group using the received user ID and selects master images that can be used as user disk images (SS111). The system management server 10 obtains the iSCSI disk information for the logical disk on which the selected master disk images are stored (SS112) and sends a request to the storage device 20a (20b) asking that the master disk images be copied to the logical disk on which the user disk images are to be stored (SS113). Upon receiving the disk image copy request, the storage device 20a (20b) copies the master disk images to the logical disk on which the user disk images are to be stored, and when copying is completed, it sends a copy completion notification to the system management server 10 (SD110). Upon receiving the copy completion notification, the system management server 10 sends a copy completion notification to the centric PC 40 (42). If the copying is completed normally, the system management server 10 registers image information in the user disk image information.

Bootup and Shutdown of Desktop Centric PC

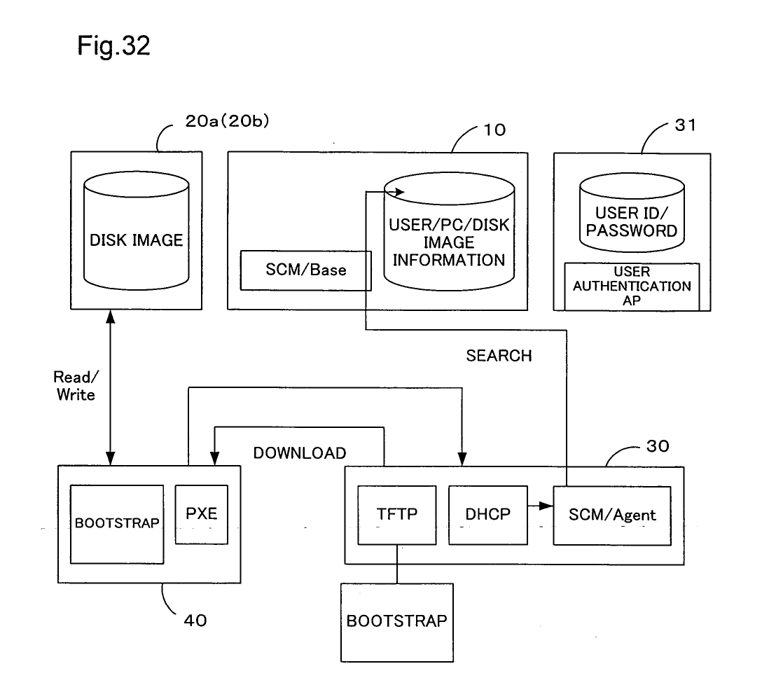

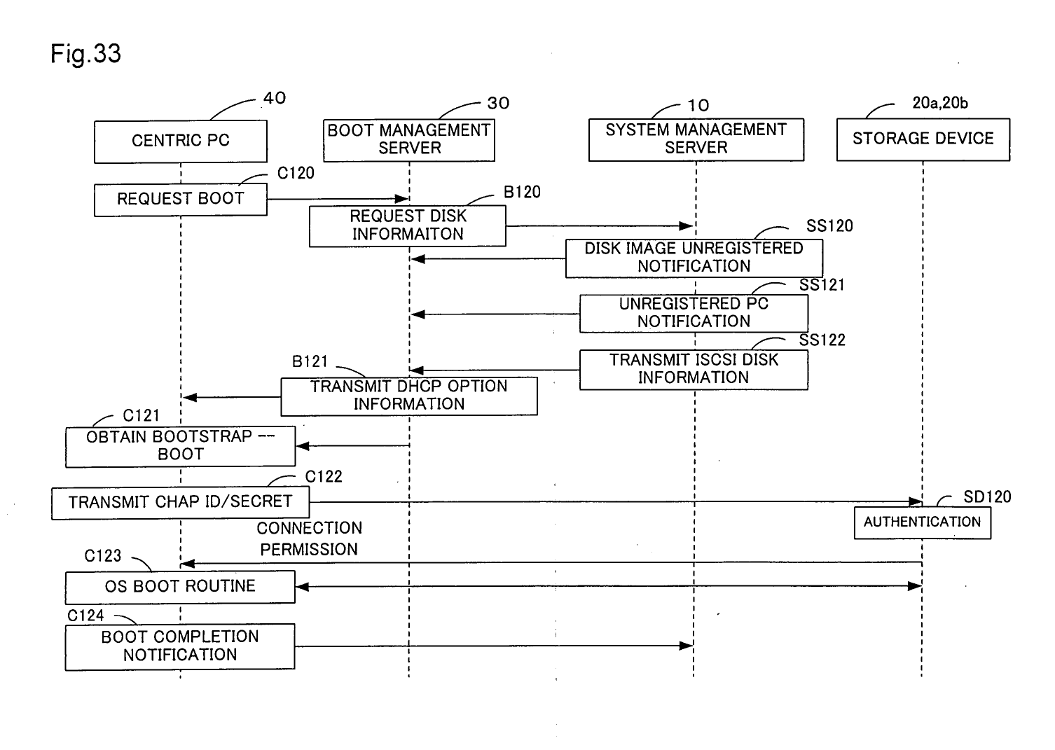

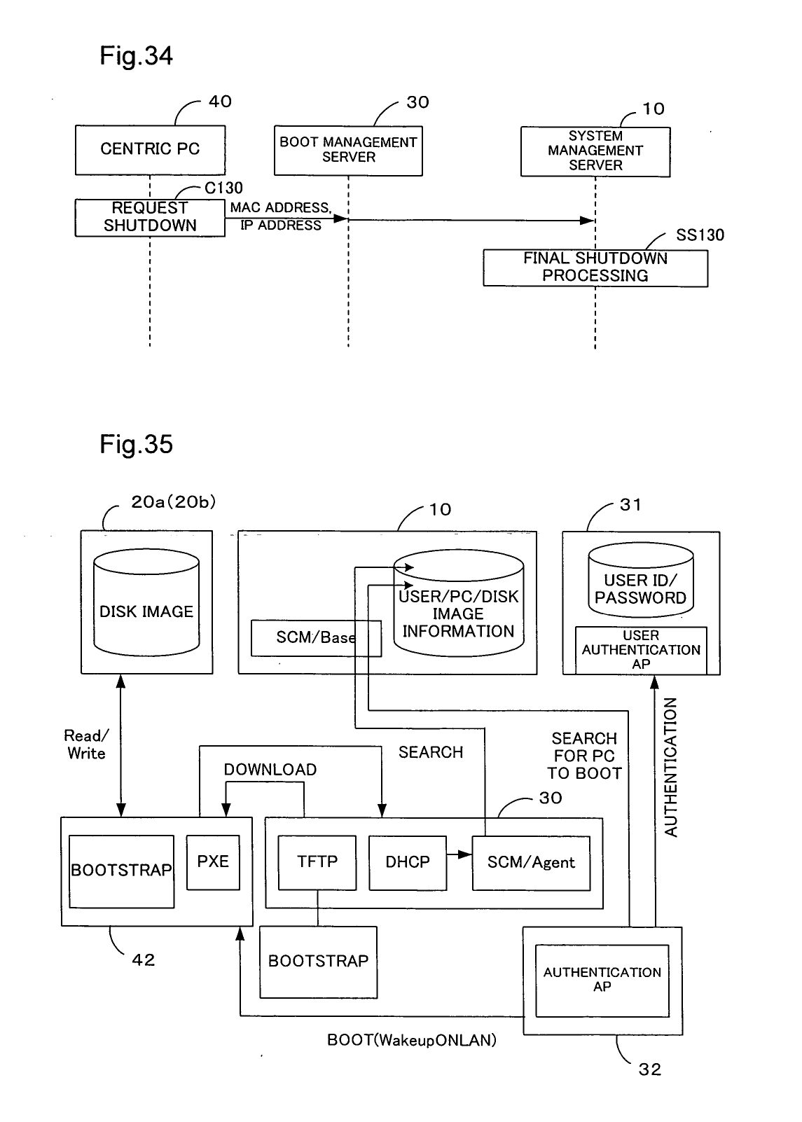

The bootup and shutdown routines for a desktop centric PC 40 will now be described with reference to FIGS. 32 through 34. FIG. 32 is an explanatory drawing showing the system construction involved in the execution of the desktop centric PC 40 bootup and shutdown routines. FIG. 33 is a flow chart showing the desktop centric PC 40 bootup routine. FIG. 34 is a flow chart showing the desktop centric PC 40 shutdown routine executed.

The system construction involved in the execution of the bootup and shutdown of a desktop centric PC 40 in the storage-centric system will now be described with reference to FIG. 32. The desktop centric PC 40 (PXE program) obtains DHCP options and a bootstrap program from the boot management server 30. The centric PC 40 executes the obtained bootstrap program to connect to the storage device 20a (20b) and executes the corresponding disk images. As a result, the operating system and application programs are sequentially booted, and the centric PC 40 can execute operations commanded by the user (i.e., reading/writing) to the storage device 20a (20b). The boot management server 30 (SCM/Agent module BAM) accesses the system management server 10, searches for and obtains iSCSI disk information and creates the DHCP options.

The centric PC 40 bootup routine will now be described in detail with reference to FIG. 33. The centric PC 40 executes the PXE program, sends its MAC address to the boot management server 30 and requests therefrom an IP address and DHCP options (C120). Upon receiving the request from the centric PC 40, the boot management server 30 (SCM/Agent module BAM) requests from the system management server 10 disk information that corresponds to the MAC address sent from the centric PC 40 (B120). Upon receiving the request from the boot management server 30, the system management server 10 determines whether or not the received MAC address is registered in the user disk image information as user information, and if the received MAC address has not been registered, it determines whether or not it is registered in the PC pool information as user information.

Where the received MAC address is registered in the PC pool information, the system management server 10 notifies the boot management server 30 that the user disk images corresponding to the centric PC 40 that sent the boot request is not registered (SS120). Where the received MAC address is not registered in the PC pool information, the system management server 10 notifies the boot management server 30 that the centric PC 40 that sent the boot request is an unregistered computer (unregistered PC) (SS121).

On the other hand, where the user disk images corresponding to the received MAC address are registered, the system management server 10 sends to the boot management server 30 iSCSI disk information (the current communication port information, the primary and secondary communication port information, and the host information) and the boot initiator name and PC type information for the disk user (step S122). In this example, because a desktop PC is being booted, CHAP authentication information is not sent.

The SCM/Agent module BAM of the boot management server 30 creates DHCP option information using the iSCSI disk information, boot initiator name and PC type information. The DHCP module BS3 sends to the centric PC 40 the IP address to be used thereby, the IP address of the DHCP server, i.e., the boot management server 30, the TFTP server address, the boot loader program name and the DHCP option information (B121).

The centric PC 40 uses the TFTP server address to access the TFTP module BS2, obtain the program matching the boot loader program name and execute a boot (C121).

Where the PC type information indicates a desktop computer, the centric PC 40 on which the bootstrap program has started waits for user input of the user ID and password (equivalent to CHAP authentication information). When the user inputs the user ID and password, the bootstrap program uses the input CHAP authentication information (CHAP ID and secret) and the initiator name included in the DHCP options to commence processing to connect to the storage device 20a (20b) having the current communication port address included in the DHCP options (C122). At this stage, the communication with the storage device 20a (20b) is carried out by the bootstrap program.

Having received the initiator name and CHAP authentication information, the storage device 20a (20b) executes host authentication and CHAP authentication using the host group information (SD120). Where CHAP authentication information matching the received CHAP authentication information exists in the host group information, authentication is successful, and the storage device 20a (20b) sends a connection permitted notification to the centric PC 40. Having received the connection permitted notification, in order to boot the operating system, the centric PC 40 connects to the current communication port, downloads drivers and boots the operating system (C123). Subsequent communications with the storage device 20a (20b) are carried out via the iSCSI and network drivers.

When the operating system is booted, the iSCSI driver is booted as well. The iSCSI driver obtains from the bootstrap program the IP address and DHCP option information obtained from the DHCP server, as well as the user-input CHAP authentication information. After the IP address is set in the network driver and the driver is booted, The iSCSI driver begins processing to connect to the storage device 20a (20b) having the current communication port address included in the DHCP options using the initiator name included in the DHCP options and loads necessary application programs. Where the iSCSI driver can perform multipathing, the path to the storage device 20a (20b) can be switched using the primary/secondary communication port information when disconnection of the current communication port is detected.

When the SCM/Client module SCCM is booted on the centric PC 40, the SCM/Client module SCCM obtains from the bootstrap program the IP address of the DHCP server, i.e., the boot management server 30. It then uses the IP address and MAC address of the centric PC as arguments and notifies the system management server 10 (SCM/Base module SBM) of the bootup of the operating system via the boot management server 30 (SCM/Agent module BAM) (C124). In other words, in this embodiment, the notification to the SCM/Base module SBM of the bootup or shutdown of the SCM/Client module SCCM is executed by the SCM/Agent module BAM of the boot management server 30. The system management server 10 (SCM/Base module SBM) changes the PC state in the user disk image information to ‘boot completed’.

The centric PC 40 shutdown routine will now be described with reference to FIG. 34. When the operating system in a centric PC 40 is shutdown, the SCM/Client module SCCM is started. The SCM/Client module SCCM notifies the system management server 10 (SCM/Base module SBM) of the shutdown of the operating system via the SCM/Agent module BAM. When the shutdown notification is issued, the SCM/Client module SCCM sends to the system management server 10 the MAC address and the IP address of the centric PC 40 (C130).

The system management server 10 then carries out final shutdown processing (SS130). Specifically, the SCM/Base module SBM changes the PC state in the user disk image information to ‘hut down’.

Blade Centric PC 42 boot/Shutdown

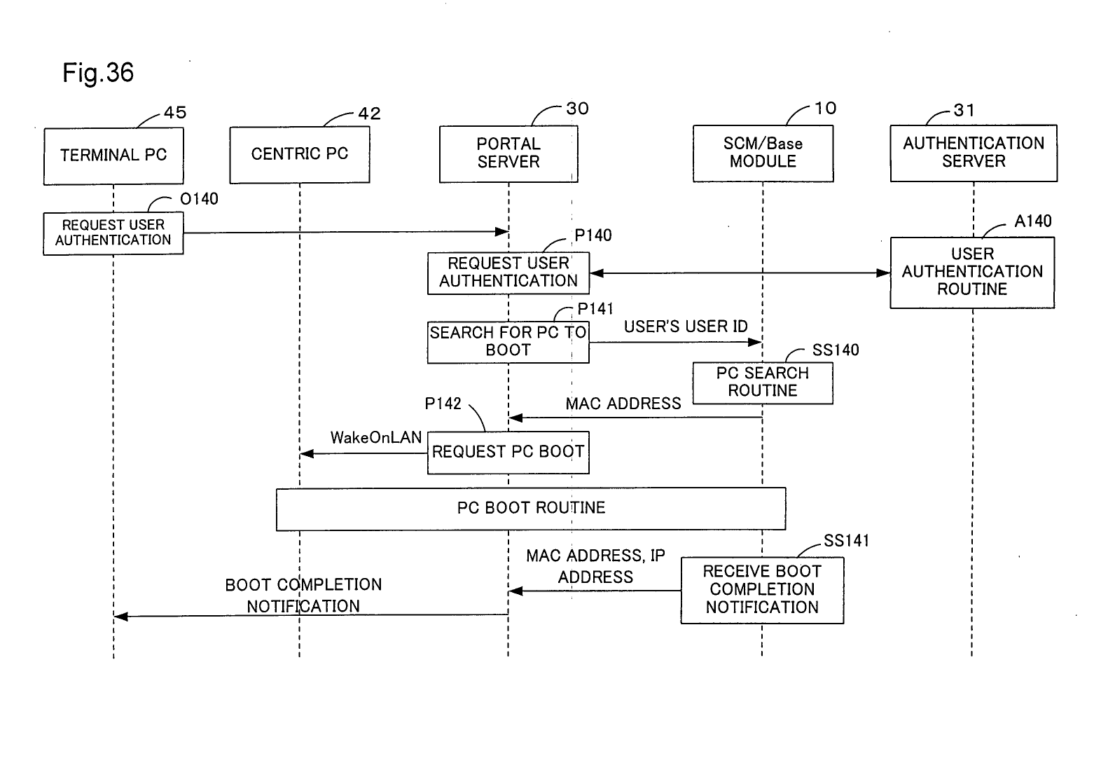

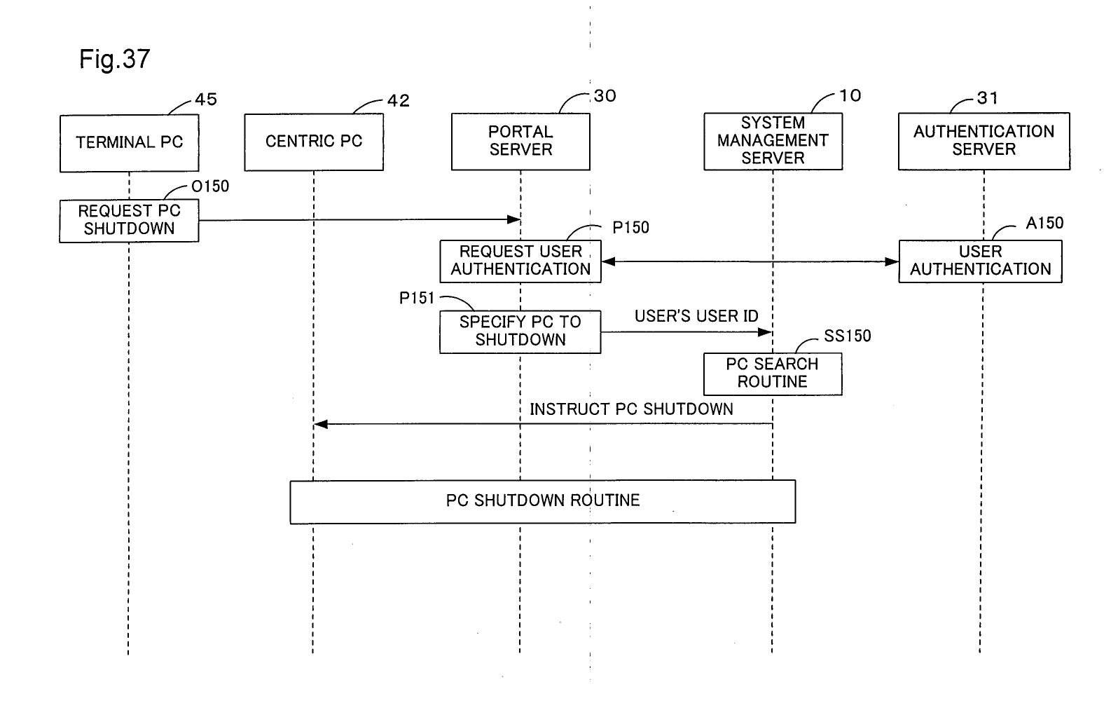

The blade centric PC 42 boot and shutdown routines will now be described with reference to FIGS. 35 through 37. FIG. 35 is an explanatory drawing showing the system construction involved in the execution of the blade centric PC 42 boot and shutdown routines. FIG. 36 is a flow chart showing the blade centric PC 42 bootup routine. FIG. 37 is a flow chart showing the blade centric PC 42 shutdown routine.

Referring to FIG. 35, the system construction involved in the execution of the blade centric PC 42 boot and shutdown routines within the storage-centric system will now be described. A terminal PC residing outside the storage-centric system accesses the portal server 32 comprising a portal to the storage-centric system and starts a blade centric PC 42. The portal server 32 accesses the authentication server 31 in order to check whether or not the user using the terminal PC is a user authorized to use the storage-centric system. If user authentication is successful, the portal server 32 accesses the system management server 10 and searches for a blade centric PC 42 to be booted. The portal server 32 then uses WakeupONLAN to boot the blade centric PC 42 (PXE program) found as a result of the search. The blade centric PC 42 (PXE program) obtains DHCP options and a bootstrap program from the system management server 10. The blade centric PC 42 executes the obtained bootstrap program, connects to the storage device 20a (20b), and executes the corresponding disk images. As a result, the operating system and application programs are sequentially booted, and the blade centric PC 42 can execute on the storage device 20a (20b) operations commanded and input by the user (i.e., reading/writing) from the terminal PC via the portal server 32. The boot management server 30 (SCM/Agent module BAM) accesses the system management server 10, seeks and obtains iSCSI disk information, and generates the DHCP options.

The blade centric PC 42 bootup routine will now be described in detail with reference to FIG. 36. A terminal PC requests user authentication from the portal server 32. Upon receiving this authentication request, the portal server 32 requests that user authentication be carried out by the authentication server 31 (P140). The authentication server 31 executes user authentication using the user authentication information (A140) and notifies the portal server 32 of the authentication result.

The portal server 32 then sends the user's user ID to the system management server 10 and requests a search for a PC to be booted (P141). The system management server 10 (SCM/Base module SBM) executes a search for a PC to be booted (SS140). Specifically, the system management server 10 selects user disk image information that matches the received user ID, and if the PC allocation method in the selected user disk image information is ‘tatic’, it notifies the portal server 32 of the MAC address of the allocated PC registered in the PC pool information. On the other hand, if the PC allocation method in the selected user disk image information is ‘dynamic’, the system management server 10 selects from among the unallocated PCs registered in the PC pool a PC having a matching PC type and PC group, registers the MAC address and model in the user disk information and notifies the portal server 32.

The portal server 32 requests bootup from the blade centric PC 42 having the received MAC address (P142). Specifically, it boots the blade centric PC 42 having the received MAC address via the WakeupONLAN function known in the prior art.

The centric PC bootup routine previously described with reference to FIG. 33 is then carried out. However, because the PC type is a blade-type PC, the bootstrap program obtains CHAP authentication information not via user input but rather from the DHCP option information. When a boot completion notification is received from the blade centric PC 42 comprising the bootup target (SS141), the system management server 10 (SCM/Base module SBM) sends to the portal server 32 the MAC address and IP address of the blade centric PC 42 that has been booted. The portal server 32 then notifies the terminal PC that bootup has been completed.

The blade centric PC 42 shutdown routine will now be described with reference to FIG. 37. A terminal PC sends a PC shutdown request to the portal server 32 (0150). Upon receiving this shutdown request, the portal server 32 sends an authentication request to the authentication server 31 (P150), whereupon the authentication server 31 performs user authentication using the user authentication information (A150) and notifies the portal server 32 of the authentication result.

When the notification of successful authentication is received, the portal server 32 sends the user ID of the user to the system management server 10 and requests PC shutdown (P151). The system management server 10 then uses the user disk image information to specify the blade centric PC 42 that matches the received user ID (SS150) and requests shutdown of the specified blade centric PC 42. The centric PC shutdown routine described with reference to FIG. 34 is then executed.

As described above, according to the system management server 10 pertaining to this embodiment, the states of the primary and secondary ports of the storage devices 20a, 20b can be monitored, i.e., whether the communication ports are in a communication-enabled state or communication-disabled state can be monitored. Therefore, where the primary communication port comprising the current communication port becomes disabled, for example, the secondary communication port can be immediately set as the current communication port. As a result, a termination of access of servers and client computers to the storage devices 20a, 20b can be prevented. Therefore, the reliability of communications within the storage-centric system can be improved.

Furthermore, where a function server that performs backup or virus scanning is to access the storage devices 20a, 20b, the communication port having fewer connections is set as the current communication port. Therefore, the burden on the communication ports can be reduced and backup and virus scanning can be performed and completed quickly.

### Other Embodiments

(1) In the above embodiment, dedicated PCs were used as the blade centric PCs 42, but a general desktop PC may be used as a blade centric PC 42.

(2) In the above embodiment, a situation was described in which the storage devices 20a, 20b each included two communication ports, i.e., a primary and a secondary communication port, but three or more ports may be used so long as the ports are made redundant. In this case, the system management server 10 (SCM/Mom module SMM) monitors three or more communication ports and where the current port is detected to be in a disabled state, a new communication port from among the remaining communication ports is appropriately set as the current communication port.

A diskless computer operation management system, management computer and client computer access management method pertaining to the present invention were described above based on an embodiment, but the above embodiment was described simply for ease of understanding of the present invention, and the present invention is not limited thereby. The present invention may be modified or improved within the essential scope thereof consistent with the Claims set forth herein, and equivalent technologies and methods are naturally included within the present invention.

1. A management computer that manages access by client computers to a storage system that includes multiple communication ports, said management computer comprising:
a monitoring module that monitors the operating states of the multiple communication ports of said storage system;
a storage unit that stores current communication port information regarding the communication port among said multiple communication ports that is currently allocated to said client computers, as well as port information including information identifying each of said multiple communication ports and information regarding the operating states of said multiple communication ports; and
a switching module that, where a change in the operating state of said current communication port is detected by said monitoring module, replaces said current communication port with a different communication port among said multiple communication ports and updates the current communication port information and the port information that are stored on said storage unit.

2. A management computer according to claim 1, wherein the information identifying each said communication port includes a target name and an Internet protocol address.

3. A management computer according to claim 1, wherein said management computer further includes a transmission module that, where a change in the operating state of said current communication port is detected by said monitoring module, transmits to said client computers said post-switch current communication port information and the updated communication port information that are stored on said storage unit.

4. A management computer according to claim 1, wherein said management computer further includes a transmission module that, where all of said multiple communication ports are in a communication-enabled operating state, transmits to said client computers said identifying information for all of said multiple communication ports and said current communication port information that are stored on said storage unit.

5. A management computer according to claim 1, wherein said management computer further includes a transmission module that, where some but not all of said multiple communication ports are in a communication-enabled operating state, transmits to said client computers the information identifying the communication-enabled communication ports among said multiple communication ports and said current communication port information that are stored on said storage unit.

6. A management computer according to claim 4, wherein where all of said multiple communication ports are in a communication-disabled operating state, said transmission module does not transmit to said client computers the said communication port identifying information or said current communication port information that are stored on said storage unit.

7. A management computer that manages access to a storage system that includes multiple communication ports by function computers that execute prescribed operations with respect to said storage system, said management computer comprising:
a monitoring module that monitors the operating states of the multiple communication ports of said storage system;
a storage unit that stores current communication port information regarding the communication port among said multiple communication ports that is currently allocated to said client computers, as well as port information including information specifying each of said multiple communication ports and information regarding the operating states of said multiple communication ports; and
a transmission module that, where it is detected by said monitoring module that all of said multiple communication ports are in a communication-enabled operating state, transmits to said client computers the information identifying the port among said multiple communication ports that has the fewest used resources and said current communication port information that are stored on said storage unit.

8. A management computer that manages access by client computers to a storage system that includes a primary communication port and a secondary communication port, said management computer comprising:
a monitoring module that monitors the operating states of the primary and secondary ports of said storage system;
a storage unit that stores current communication port information regarding the communication port that is currently allocated to said client computers, as well as port information including the target names and Internet protocol addresses of said primary and secondary communication ports and information regarding the operating states of said primary and secondary communication ports;
a current communication-port setting module that sets said primary communication port as the default current communication port and, and where said monitoring module detects that said current communication port is in a communication-disabled operating state, sets the primary or secondary communication port that is not said current communication port as a new current communication port.

9. A management computer that manages access by client computers to a storage system that includes a primary communication port and a secondary communication port, said management computer comprising:
a monitoring module that monitors the operating states of the primary and secondary ports of said storage system;
a communication port switching module that, where a change in the operating state of said communication port allocated to said client computers is detected, replaces said communication port with a different communication port among said multiple communication ports; and
a notification module that notifies said client computers of said replacement communication port.

10. A client computer that communicates with a storage system that includes multiple communication ports, via a communication port allocated thereto by a management computer, said client computer comprising:
a communication module that communicates with said storage system via a communication port allocated by said management computer; and
a port switching module that, where a notification regarding a change of communication port is received from said management computer, replaces the communication port that said client computer is currently using with the communication port specified by the notification.

11. A management method of managing access by client computers to a storage system that includes multiple communication ports, said management method comprising:
monitoring the operating states of said communication ports of said storage system;
storing current communication port information regarding the communication port among said multiple communication ports that is currently allocated to said client computers, as well as port information including information identifying each of said multiple communication ports and information regarding the operating states of said multiple communication ports; and
where a change in the operating state of said current communication port is detected by said monitoring module, replacing said current communication port comprising the communication port currently allocated to said client computers with a different communication port among said multiple communication ports, and updating said current communication port information and said port information that are stored on said storage unit.
